(19) United States
(12) Patent Application Publication
(10) Pub. No.: US 2026/0368078 A1
(43) Pub. Date: Nov. 19, 2026

(54) MEMORY MANAGEMENT FOR MONOLITHIC KERNEL SYSTEM

(71) Applicant: NVIDIA Corporation, Santa Clara, CA (US)

(72) Inventors: Igor STOPPA, Uusimaa (FI); Mohamed Saad ABDELHAMEED, Dachau (DE); Vito MAGNANIMO, Munchen (DE); Raghavendra Vishnu Kumar, Bangalore (IN)

(21) Appl. No.: 19/273,763

(22) Filed: Jul. 18, 2025

Related U.S. Application Data
(60) Provisional application No. 63/816,860, filed on Jun. 3, 2025.
(60) Provisional application No. 63/811,315, filed on May 23, 2025.
(60) Provisional application No. 63/807,390, filed on May 16, 2025.

(51) Int. Cl. G06F 12/02

(52) U.S. Cl. CPC G06F 12/023; G06F 2212/72

(57) ABSTRACT

In various examples, memory resources of a monolithic system may be allocated to individual groups of functionalities of one or more groups of functionalities of the monolithic kernel system. One or more memory pages are allocated to one or more threads of the monolithic kernel system, in which the one or more memory pages are selected from the individual memory pools based at least on categories assigned to the one or more threads. As the allocation is being implemented and following the allocation, one or more validation processes may be performed. In some embodiments, the validation processes may include one or more of: implementing a memory allocation structure, tracking allocation status of individual memory pages, identifying overlaps in the allocated memory pages, and defining the memory pools including continuous ranges of memory pages.

### CROSS-REFERENCE TO RELATED APPLICATIONS

This application claims the benefit of U.S. Provisional Application No. 63/807,390 filed on May 16, 2025, U.S. Provisional Application No. 63/811,315 filed on May 23, 2025, and U.S. Provisional Application No. 63/816,860 filed on Jun. 3, 2025, the contents of which are hereby incorporated by reference in their entirety.

### BACKGROUND

Machines, such as autonomous or semi-autonomous machines and robots, include various systems and/or components configured for various functionalities. Such systems and functionalities – when combined – allow the machines to perform operations. For example, a machine may include a powertrain system (e.g., engine, transmission, drivetrain, etc.), a brake system (e.g., anti-lock braking system (ABS), electronic stability control, etc.), a steering system (e.g., power steering, rack and pinion, etc.), a suspension system (e.g., shock absorbers and struts, front and rear suspension, etc.), a fuel system (e.g., fuel tank, fuel pump, fuel injectors, etc.), an electrical system (e.g., battery, alternator, wiring and connectors, etc.), a cooling system (e.g., radiator, thermostat, coolant, etc.), safety systems (e.g., airbags, seatbelts, advanced-driver-assistance systems (ADAS), etc.), a climate control system (e.g., heating, ventilation, and air-conditioning (HVAC), etc.), among others that may operate together to facilitate operation of the vehicle, machine, or robot.

In some instances, the machines may be operated using monolithic operating systems. A monolithic operation system (OS), such as Linux, is an operating system architecture in which the entire kernel is implemented as a single, large, static program. The kernel is configured to manage hardware and system resources, including certain services such as process management, memory management, device management, file system management, system calls, security and access control, among others. Without strict separation between components, the monolithic OS or monolithic kernels tend to have lower overhead and improved performance compared to other types of operating systems.

In general, monolithic systems or kernels implement a concept of memory paging, in which memory pages are used as a fundamental unit of memory management. The memory is divided into fixed-size blocks or pages to improve management, isolation, and protection of memory. In some instances, the monolithic kernels implement virtual memory to provide different processes and/or functionalities the illusion of having private address spaces. For instance, virtual addresses are not used to directly access physical memory, such as RAM. Instead, the kernel maps the virtual addresses to physical memory addresses, where the physical memory addresses may correspond to different memory pages.

Although monolithic kernels provide certain benefits of improved performance and lower overhead, the monolithic OSs and/or kernels also carry certain challenges or risks. For example, monolithic kernels lack fault isolation such that in instances in which a part of the kernel incurs issues such as driver crashes or malfunctions, the entire system may be affected. As such, an issue in one part of the system can propagate and affect the entire OS. Additionally, monolithic kernels have less control over resource management compared to microkernels, in that monolithic kernels cannot easily isolate management for each individual component. For instance, a memory management unit may not be used to protect data with sub-page granularity.

### SUMMARY

Embodiments of the present disclosure relate to memory management of a monolithic kernel system. Systems and methods are disclosed that define a set of memory pools including respective ranges of memory pages. The memory pages are allocated to different threads and/or contexts from different memory pools based at least on respective purposes of the threads.

In contrast to conventional systems in which memory resources are allocated from one pool of memory resources, allocation of memory pages may be implemented with respect to multiple memory pools. One or more memory pools are generated for a monolithic kernel system, in which the one or more memory pools respectively include a range of memory pages of memory resources of the monolithic kernel system. The individual memory pools are allocated and/or assigned to individual groups of functionalities of one or more groups of functionalities of the monolithic kernel system. In response to obtaining a request to perform one or more operations with respect to the memory resources from a thread, an assigned category or purpose of the thread is determined. An individual memory pool from the one or more memory pools that are associated with the assigned category of the thread is identified, and one or more memory pages from the identified individual memory pool are allocated to the thread.

One or more embodiments of the present disclosure relate to enforcing memory management rules for a monolithic kernel system. Systems and methods are disclosed that define access rules for different threads.

In contrast to conventional systems in which the memory resources and/or the memory pages of the monolithic system are shared by all threads, the embodiments of the present disclosure define and assign different access rules for different threads. The access rules may set read, write, and/or execute permissions for different memory regions for different threads. In response to obtaining a request to perform one or more operations with respect to memory resources of a monolithic kernel system from a thread, an access level assigned to the thread may be determined. Access to one or more memory pages of the memory resources of the monolithic system may be granted based at least on the access level.

One or more embodiments of the present disclosure relate to context transition of a thread. Systems and methods are disclosed that assign multiple contexts to individual threads, in which the individual threads transition between the multiple contexts based at least on type of operation or functionality being performed by the threads.

In contrast to conventional systems in which threads perform different types of operations in a manner that may cause interferences, one or more embodiments of the present disclosure assigns a base context of a set of base contexts to individual threads of one or more threads of a monolithic kernel system based at least on one or more respective safety levels associated with one or more functionalities operated using the individual threads. In response to receiving a request to perform a functionality with respect to memory resources of the monolithic kernel system from a thread, the thread is caused to perform the functionality in the base context or a general context based at least on a type of the functionality. In some embodiments, the thread may perform safety-related functionality in the base context and perform other general functionalities in the general context. An active kernel memory map used by a memory management unit associated with a core running the thread may change based at least on current context of the thread, such that the thread operating in the general context does not have access to the memory pages allocated to the safety-related functionalities.

One or more embodiments of the present disclosure relate to validation of memory allocations for a monolithic system. Systems and methods are disclosed that allocate memory pages to individual threads of the monolithic kernel system, and the allocation is validated via one or more validation processes.

In contrast to conventional systems in which the issues with memory allocation are addressed after the issues occur, embodiments of the present disclosure may help reduce the occurrences of these issues. In some embodiments, one or more memory pools for a monolithic kernel system may be generated, in which the one or more memory pools respectively include a range of memory pages. Individual memory pools of the one or more memory pools are allocated to individual groups of functionalities of one or more groups of functionalities of the monolithic kernel system. One or more memory pages are allocated to one or more threads of the monolithic kernel system, in which the one or more memory pages are selected from the individual memory pools based at least on categories assigned to the one or more threads. As the allocation is being implemented and following the allocation, one or more validation processes may be performed.

In some embodiments, the validation processes may include one or more of implementing a memory allocation structure, tracking allocation status of individual memory pages, identifying overlaps in the allocated memory pages, and defining the memory pools include continuous range of memory pages.

### BRIEF DESCRIPTION OF THE DRAWINGS

The present systems and methods for managing memory resources of a monolithic kernel system are described in detail below with reference to the attached figures, wherein:

FIG. 1 is a diagram of an example monolithic system implementing memory management system, in accordance with one or more embodiments of the present disclosure;

FIG. 2 is a is a diagram of another example monolithic system implementing memory management system, in accordance with one or more embodiments of the present disclosure;

FIG. 3 illustrates a table illustrating an example of access control rule, in accordance with one or more embodiments of the present disclosure;

FIG. 4A illustrates an example thread having multiple contexts, in accordance with one or more embodiments of the present disclosure;

FIG. 4B illustrates a flow diagram of a transition between multiple contexts, in accordance with one or more embodiments of the present disclosure;

FIG. 5 illustrates a flow diagram for a method of allocating memory resources of a monolithic system, in accordance with one or more embodiments of the present disclosure;

FIG. 6 illustrates a flow diagram for a method of designating memory resources and/or enforcing allocated memory resources of a monolithic system, in accordance with one or more embodiments of the present disclosure;

FIG. 7 illustrates a flow diagram for a method of transition of contexts, in accordance with one or more embodiments of the present disclosure;

FIG. 8 illustrates a flow diagram for a method of validating memory allocations, in accordance with one or more embodiments of the present disclosure;

FIG. 9A is an example of sensor locations having corresponding fields of view or sensory fields for example autonomous or semi-autonomous machines, in accordance with at least some embodiments of the present disclosure;

FIG. 9B is an illustration of an example of component and sensor locations on an autonomous or semi-autonomous vehicle, in accordance with at least some embodiments of the present disclosure;

FIG. 9C is a block diagram of an example system architecture for an autonomous or semi-autonomous vehicle, robot, and/or other machine type, in accordance with at least some embodiments of the present disclosure;

FIG. 9D is a block diagram of an example architecture of a computing system – such as a system-on-a-chip (SoC) – in accordance with at least some embodiments of the present disclosure;

FIG. 9E is a system diagram for communication between cloud-based server(s) and an example autonomous or semi-autonomous vehicle, robot, and/or other machine type, in accordance with at least some embodiments of the present disclosure;

FIG. 10 is a system diagram illustrating a three computer ecosystem, including a computing system for generating or creating artificial intelligence (AI) – such as AI training and validation data, a computing system for training artificial intelligence, and a computing system deploying the AI at the edge, in accordance with at least some embodiments of the present disclosure;

FIG. 11 is a block diagram of an example computing system for generative artificial intelligence (AI), in accordance with at least some embodiments of the present disclosure; and

FIG. 12 is a block diagram of an example computing device, in accordance with at least some embodiments of the present disclosure.

### DETAILED DESCRIPTION

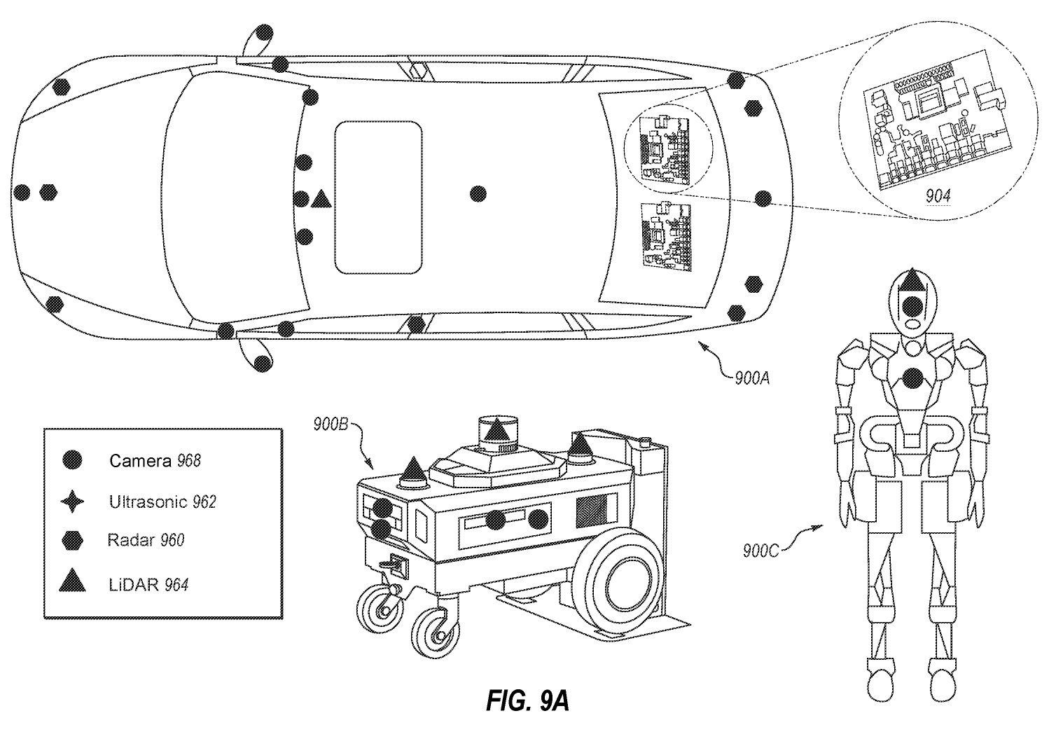

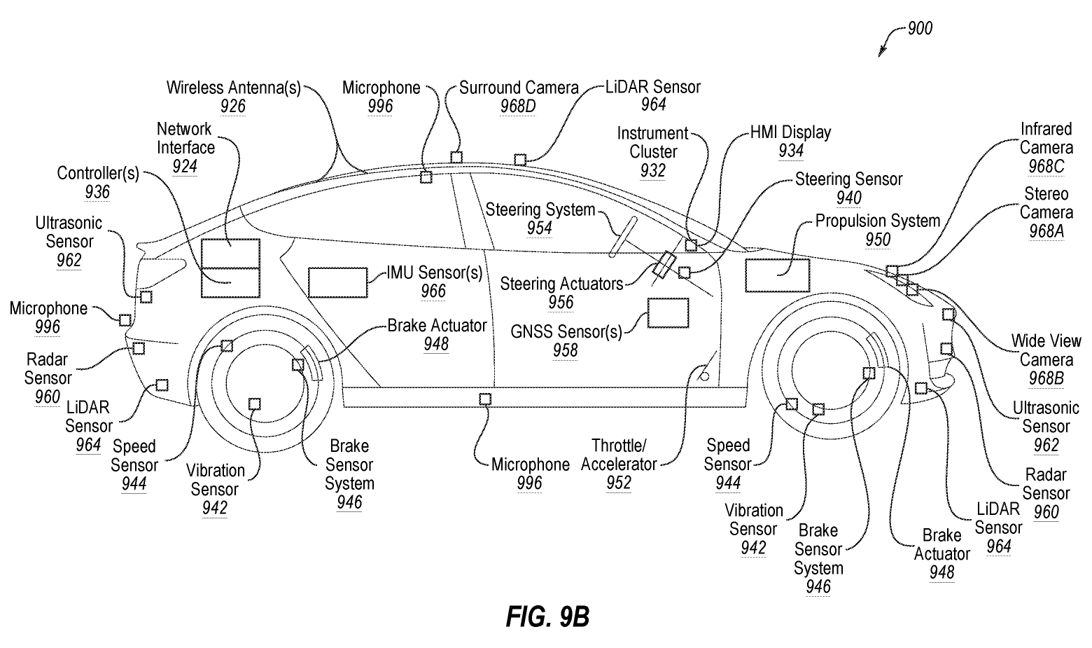

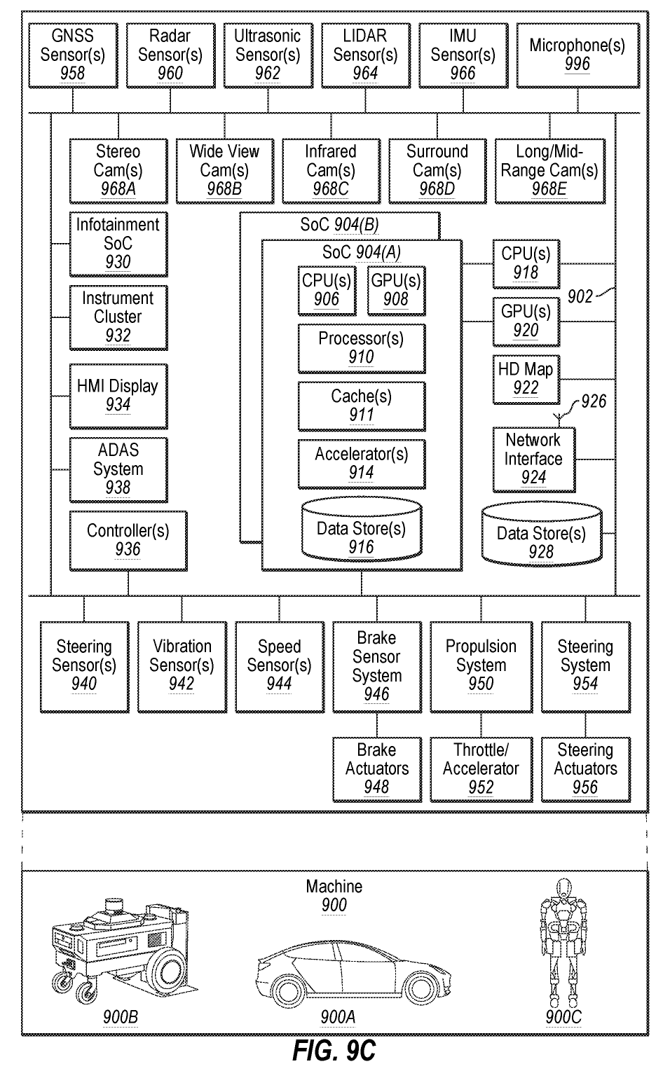

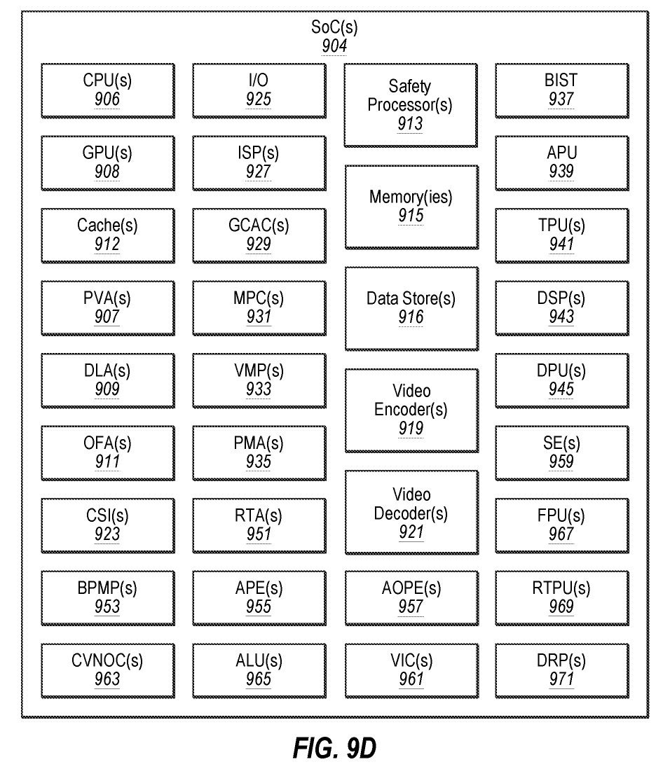

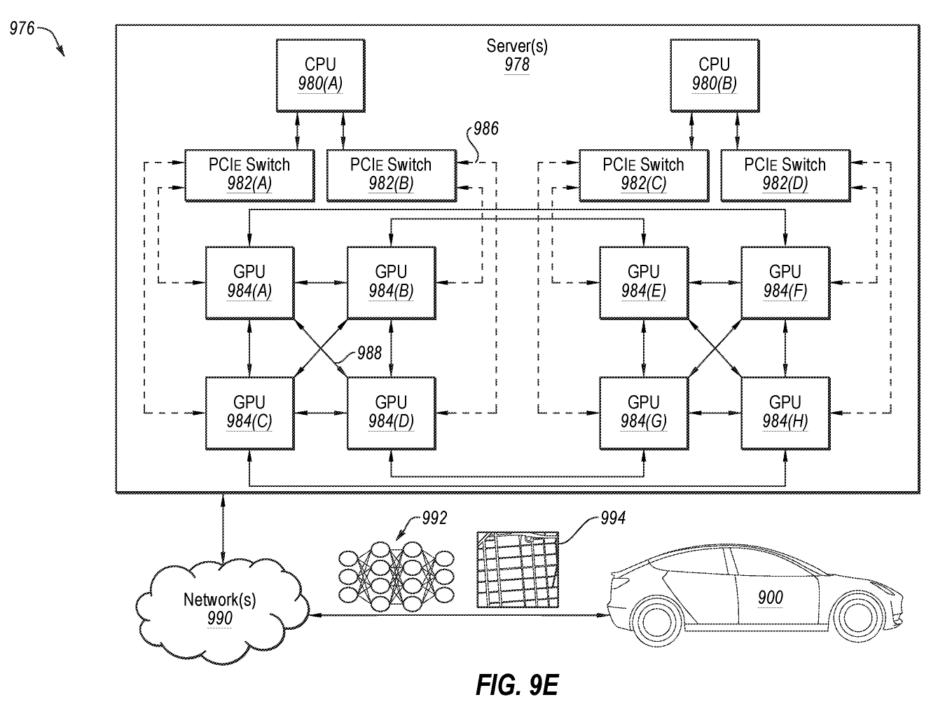

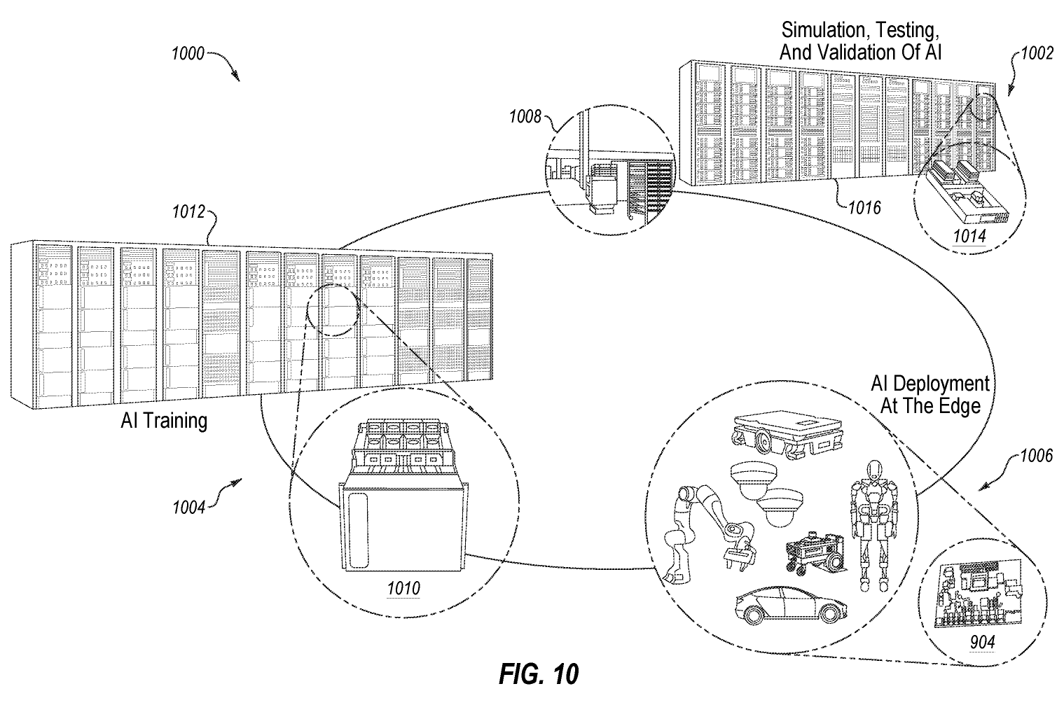

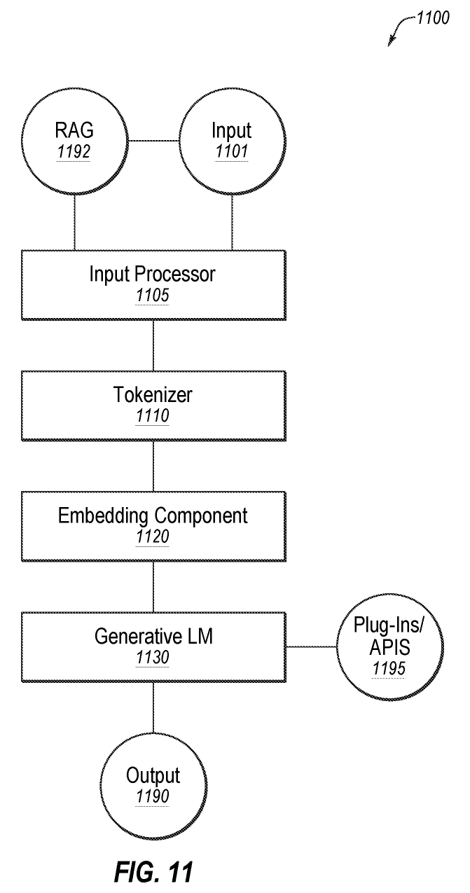

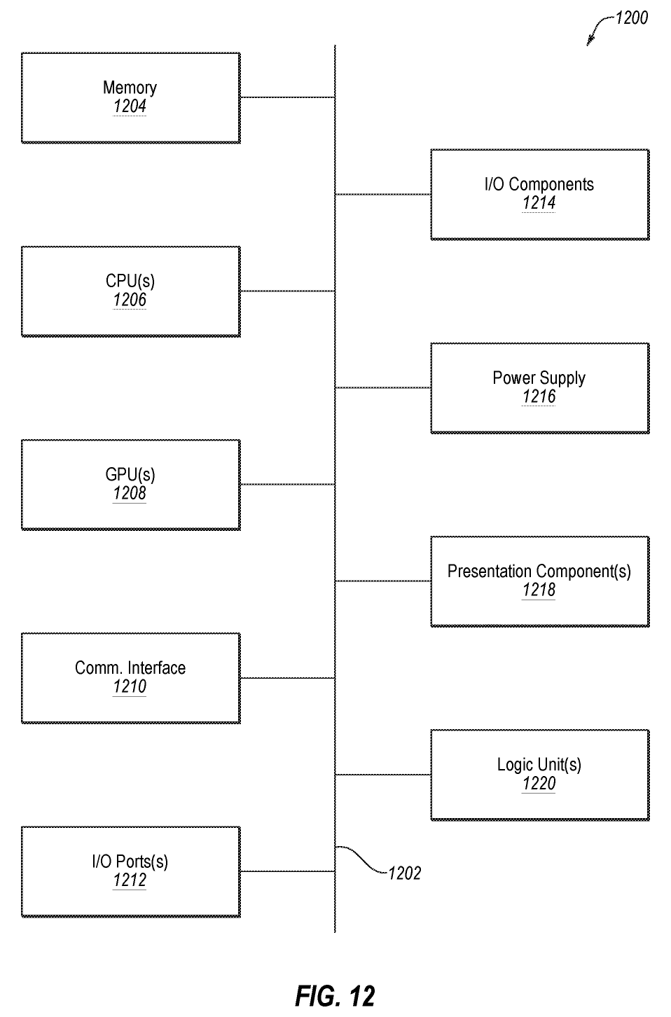

Systems and methods are disclosed related to memory management for monolithic kernel system. Although the present disclosure may be described with respect to an example autonomous or semi-autonomous vehicle, robot, and/or other machine type 900 (alternatively referred to herein as “vehicle 900,” “ego-vehicle 900,” “machine 900,” “ego-machine 900,” “robot 900,” and/or “ego-robot 900,” an example of which is described with respect to FIGS. 9A-9E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to managing the memory resources for a monolithic kernel system, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where memory management may be used. In some embodiments, the systems, methods, and/or processes described herein may be executed using similar components, features, and/or functionality to those of example machine 900 of FIGS. 9A-9E, example computing ecosystem 1000 of FIG. 10, example generative language model system 1100 of FIG. 11, and/or example computing device 1200 of FIG. 12.

One or more embodiments of the present disclosure may relate to systems and methods for memory management of a monolithic system. Memory management may include allocating the memory of the monolithic system based at least on properties of functionalities of the system. Particularly, memory pages of the monolithic system may be allocated on a page basis. For example, subsets of the memory pages may be allocated to different purposes, in which the purposes represent certain properties of functionalities. Additionally, the embodiments of the present application may help enforce and/or facilitate usage of the allocated memory pages.

In some embodiments, a memory management system of the monolithic system may be configured to allocate the memory pages based at least on a certain standard. For example, the memory management system may allocate the memory such that a continuous range of memory pages is allocated to a certain purpose or a set of functionalities sharing a specific property associated with the certain purpose. For example, the memory management system may allocate the memory pages such that a continuous range of memory pages is used by different functionalities sharing the specific property.

In some embodiments, the allocation of memory may define the threads that may read and/or write to different memory pools (e.g., ranges of memory pages). For example, the memory management system, and in particular a memory management unit of the memory management system, may be configured to implement and/or enforce the allocated memory pages such that the threads only read from and/or write to the memory pages that are allocated to the particular purpose associated with the threads. In these and other embodiments, a thread may refer to a unit of execution within a process or a program that is running in the system. A process may have multiple threads, in which individual threads represent distinct paths of execution within the process. In a monolithic operating system (OS), the threads may be managed by a kernel, or a single, unified software layer that is responsible for managing all core system functions including process scheduling, memory management, hardware communication, file systems, and system calls, among others. For example, the kernel may schedule threads to run on the processor, and manage operations such as thread creation, scheduling, and termination. In some embodiments, a thread may include one or more contexts. A context of a thread may refer to all information that the OS needs to manage the execution of the thread. For example, the context may include state of registers, memory, central processing unit (CPU) usage, and/or other relevant data.

In some embodiments, the allocated memory may be enforced such that the regular kernel code or quality management (QM) functions do not alter memory allocated to specific purpose. For example, the regular kernel code may not alter memory in use by safety-related (SR) processes and/or functions. For instance, different threads operating under different contexts may have different access levels to the memory pages. In some embodiments, the access levels may represent ranges of memory pages that the context may read and/or write. In some embodiments, the access levels for the contexts may be determined based at least on the purpose and/or categorization of the context. For example, with respect to the safety levels (e.g., automotive safety integrity level (ASIL) levels), the contexts may read from all of the memory pages but may only write to memory pages allocated to the specific safety level associated with the contexts and the memory pages allocated to safety levels below the specific safety level associated with the contexts.

In some embodiments, a thread may have multiple contexts. For example, a thread may have a base context and a general context. A base context may refer to the initial state or foundational information that defines the thread when the thread is created. In some embodiments, the base context may be fixed as one of the possible contexts available. For example, the base context may be one of a QM context, and a set of SR contexts. The base context may represent the purpose (e.g., safety level) of the context or the thread. The general context may refer to the context in which all non-safety related functions operate.

In some embodiments, an active context of the thread may be configured to switch between the based context and the general context. An active context of a thread may refer to the current state of the thread as the thread is actively running or being executed by a processor. In some embodiments, the active context may be configured to switch between the base context and the general context based at least on the functions being performed. For example, the active context may switch to the general context to perform certain general functions (e.g., non-safety functions) and switch to the base context to perform context-specific functions.

In some embodiments, one or more validation processes may be performed at different stages to protect the allocated memory pages. For example, a first validation process may be performed as the memory pages are being allocated. The first validation process may include tracking the memory pages as the memory pages are allocated, such that specific memory pages are only allocated once. In these and other embodiments, allocating ranges of memory pages together may help track the allocation more efficiently. For example, the first memory page and the last memory page of the ranges may be tracked such that continuous range of memory pages is allocated together.

One or more embodiments of the present disclosure may help improve the operations of a monolithic system. For example, one or more embodiments of the present disclosure may be directed to a memory management system configured to improve or maintain availability of certain functionalities through allocation and/or designation of memory. In particular, the embodiments of the present disclosure may help allocate memory pages based on properties of functionalities. Additionally, the embodiments of the present disclosure may help enforce and/or facilitate usage of allocated memory pages. The embodiments of the present application may help maintain certain amount of memory for certain functions such that the monolithic system may satisfy different availability requirements for different functions.

By contrast, some existing approaches of memory management may include a form of memory allocation. All kernel components, including third-party modules and drivers, operate in the same high-privileged virtual address space. For example, unlike microkernels in which each service runs in user space with strict boundaries, monolithic system modules and kernel subsystems all operate with full memory access. For example, allocations made using certain functions such as, kmalloc(), vmalloc(), alloc_pages(), etc., return memory from a common memory pool.

Additionally, the kernel allocators do not specifically enforce access control at allocation boundaries. For example, there is no standard enforcement of the allocated memory. For example, page tables representing the memory allocations do not distinguish between which subsystem owns which memory once mapped into kernel space. Such a lack of isolation between the allocated memory and the lack of enforcement may lead to kernel spatial interference problems. The kernel spatial interference problems refer to unintended interactions or disruptions between different parts of the kernel due to shared memory space.

The kernel spatial interference problems may cause various issues, such as system crashes, silent data corruption (e.g., memory corruption leading to incorrect behavior), security vulnerabilities (e.g., a compromised module may read and write to memory that the compromised module should not have access to), unpredictable system behavior (e.g., random and intermittent failures), broken kernel subsystems, among others.

By contrast, the memory management system in accordance with one or more embodiments of the present disclosure may allocate memory pages of a monolithic system based at least on a specific categories and/or availability requirements associated with the functionalities instead of mere resource allocation. The memory management system may enforce the usage of the allocated memory at runtime such that the allocated memory. For instance, in response to receiving a request to access the memory from a functionality, the kernel may be configured to grant access to specific sets of memory pages based at least on the type of functionality. Such enforcement may help reduce chances of different functionalities accessing unauthorized memory pages. The memory management system may improve the separation of the memory resources for a monolithic system, such that certain functionalities may have uninterrupted access to memory resources.

In some embodiments, the systems and methods described herein may be performed within a simulation environment (e.g., NVIDIA’s DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine how memory resources of a monolithic system are used, etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., possible interferences caused by the different operations from within the simulation.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA’s RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA’s OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA’s PhysX software developer kit (SDK)), in order to simulate real physics and physical interactions with simulations hosted by the platform. The platform may integrate OpenUSD along with ray tracing/path tracing/light transport simulation (e.g., NVIDIA’s RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs) - which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot’s surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs) - which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice – such an inference microservice (e.g., NVIDIA NIMs) – which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples – such as where the model(s) is large – the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs - such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA’s Triton Inference Server, and/or one or more APIs for high performance deep learning inference, which may include an inference runtime and model optimizations that deliver low latency and high throughput for production applications – such as NVIDIA’s TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA’s Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models – such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

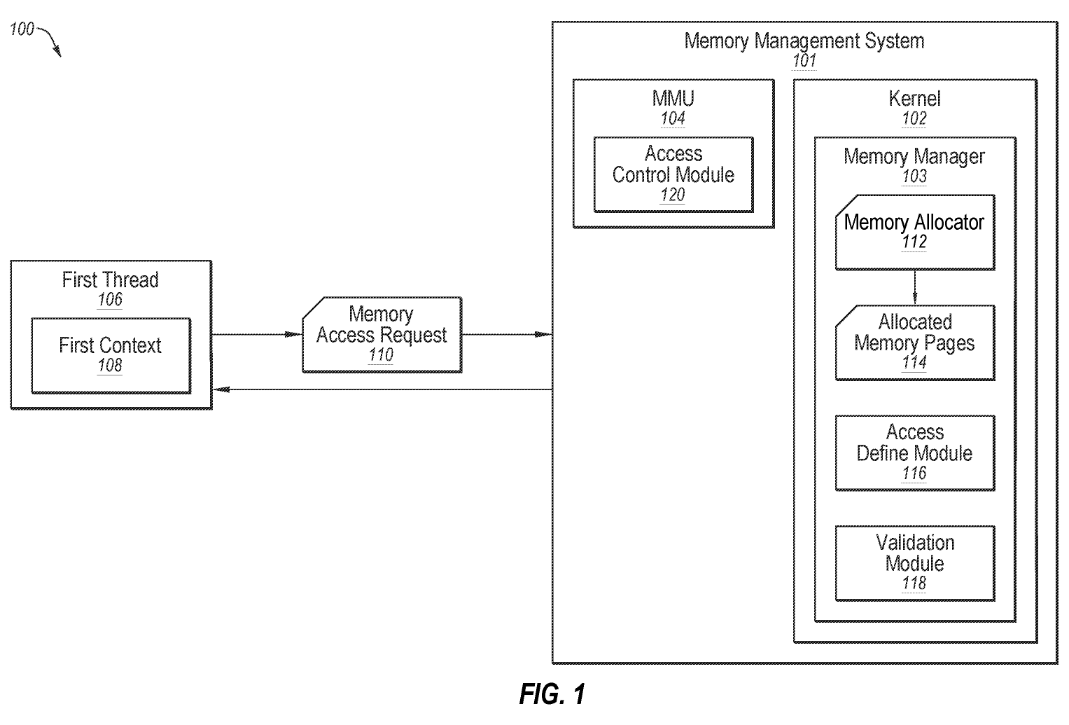

With respect to FIG. 1, FIG. 1 illustrates an example monolithic system 100 implementing memory management system, in accordance with one or more embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises – such as locally hosted servers, remotely located – such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 900 of FIGS. 9A-9E, example computing ecosystem 1000 of FIG. 10, example generative language model system 1100 of FIG. 11, and/or example computing device 1200 of FIG. 12.

In some embodiments, the monolithic system 100 may refer to an operating system, such as Linux, in which all core operating system services run in the same address space (e.g., kernel space). In general, the monolithic system 100 may include the memory management system (MMS) 101 configured to manage memory resources and/or the address space of the monolithic system 100. In these and other embodiments, the memory management system 101 may refer to a set of mechanisms and/or policies used to manage memory in the monolithic system. In some embodiments, the MMS 101 may include hardware mechanisms such as a memory management unit (MMU) 104 and software components such as a kernel 102. In general, the memory of the monolithic system 100 may be managed in fixed-size blocks called pages. Each page may have a certain size of storage. For example, a memory page may be 4 kilobytes (KB) in size.

In some embodiments, the kernel 102 may be configured to manage all system resources, including the processor, memory, devices, file systems, and inter-process communication (IPC), among others. The kernel 102 may be configured to perform process management, memory management, device management, file system management, system calls interface, among others. In some embodiments, the kernel 102 may include subsystems configured to perform different management operations of the kernel. For example, the kernel 102 may include a memory manager 103, in which the kernel relies on to abstract, protect, and allocate memory for all other kernel components and user-space applications. The memory manager 103 may be configured to handle allocating, tracking, and/or protecting the system memory. In general, the memory manager 103 may be configured to handle both virtual memory and physical memory, enforcing memory isolation, protection, paging, and/or performance optimizations.

In some embodiments, the MMS 101 may be configured to receive memory access requests from threads. For example, the MMS 101 may receive a memory access request 110 from a first thread 106. A thread is the smallest unit of execution within a process, representing an individual sequence of instructions that may be scheduled and run by the processor. In the monolithic system 100, multiple threads may share the same address space, file descriptors, and other resources, but maintain separate stacks, program counters, and registers. Threads, such as the first thread 106 may send the memory access request 110 to the MMS 101 via functions such as malloc().

In some embodiments, in response to receiving the memory access request 110, the MMS 101 may determine and/or identify memory pages allocated to the first thread 106. Particularly, the MMU 104 of the MMS 101 may be configured to validate memory access of the threads. For example, in response to a thread requesting to access memory, the MMU 104 may be configured to translate virtual addresses associated with the thread to physical addresses. In some embodiments, the MMU 104 may translate virtual addresses to physical addresses based at least on page tables or data structures maintained by the kernel 102, and in particular, the memory manager 103. The page tables may define the memory regions that different threads may access. In some embodiments, the MMU 104 may include an access control module 120. The access control module 120 may be configured to enforce memory access permissions at runtime. The access control module 120 may be configured to verify each memory access request against the permissions stored in the page table entries. In response to determining that memory pages have been already allocated to the first thread 106, the MMU 104 may allow the first thread 106 to access the allocated memory pages.

In some instances, the first thread 106 may not have allocated memory pages. In such instances, a page fault may occur, and the control may be passed to the kernel 102. The kernel may decide to allocate new memory pages or to terminate the process of the first thread 106. In instances in which the kernel 120 decides to allocate new memory pages, the memory manager 103 may be configured to handle the allocation of the memory pages to the first thread 106. The memory manager 103 may be configured to implement virtual memory, in which each process may operate in an isolated address space. The memory manager 103 may be configured handle tasks such as allocating memory pages, maintaining page table, defining memory protection policies, among others.

In some embodiments, the memory manager 103 may include a memory allocator 112 configured to allocate the memory pages. The memory allocator 112 may be configured to allocate and deallocate memory at various levels. The memory allocator 112 may provide mechanisms to distribute memory to different parts of the kernel. In some embodiments, the memory allocator 103 may be configured to distribute and/or allocate memory pages to the threads (e.g., the first thread 106) based at least on priorities and/or purposes associated with the threads. For example, the memory pages may have a set of memory pools, in which individual memory pools include continuous ranges of memory pages. The memory allocator 103 may allocate memory pages from certain memory pools to the threads based at least on the priorities and/or purposes of the threads.

In some embodiments, the priorities and/or the purposes of the threads may be determined based at least on a certain standard. In the present disclosure, a reference to priorities of the threads may include a reference to purposes of the threads. Additionally, in the present disclosure, a reference to a process and/or a functionality may include a reference to a thread running within the process and/or the functionality. In some embodiments, the priorities may be determined based at least on a safety standard. For example, the processes associated with safety of the monolithic system 100 may be assigned higher priorities than other processes that do not affect safety of the monolithic system 100. For example, a process associated with a braking system may be assigned higher priority than a process associated with infotainment systems.

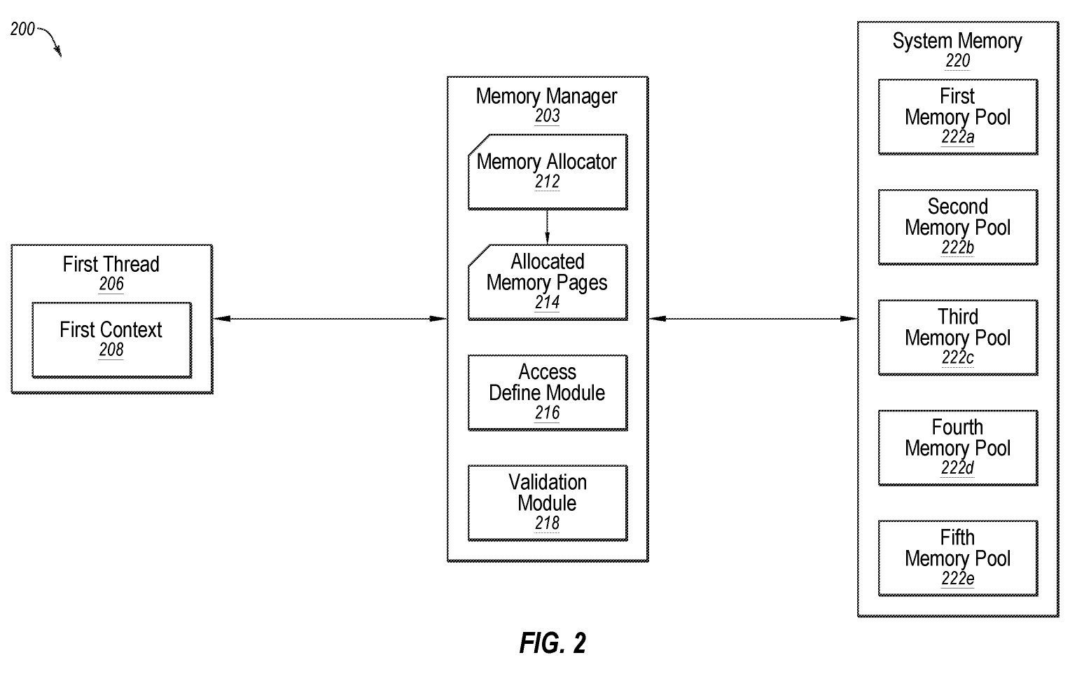

In some embodiments, the priorities may be determined based on any suitable standard. For example, the priorities may be determined and/or assigned based at least on a known safety standard such as ISO 26262, an international standard for the functional safety of electrical and electronics systems in road vehicles. In these and other embodiments, the processes may be categorized based at least on the standard, in which different categories are associated with different priorities. As an example, the functionalities or processes may be categorized based at least on the ASIL standards defined by ISO 26262. The allocation of the memory pages may be described in further detail with respect to FIG. 2 of the present disclosure.

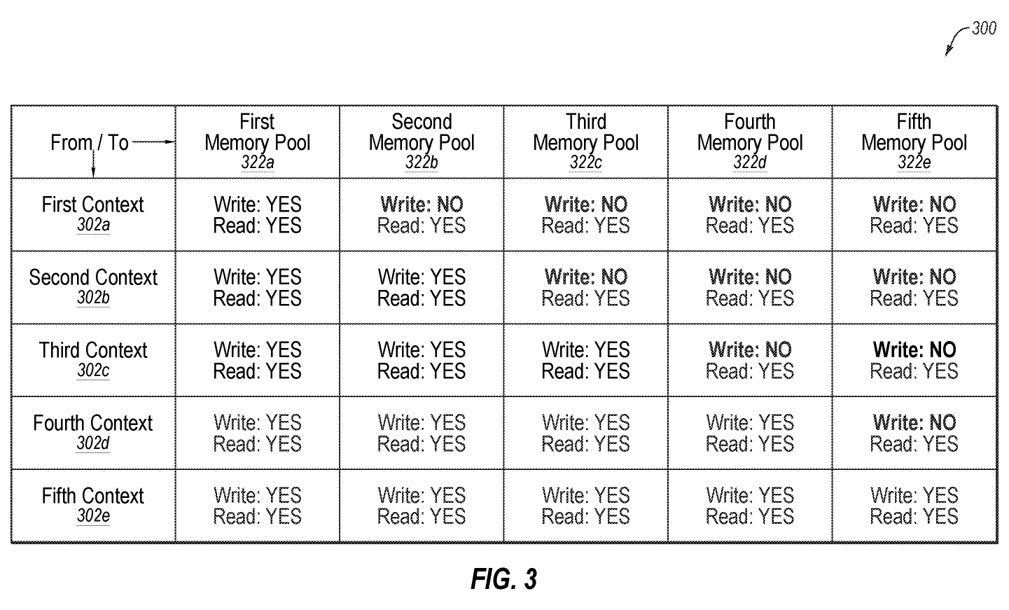

In some embodiments, the memory manager 103 may include an access define module 116. The access define module 116 may be configured to define the rules and mechanisms by which the threads may access the memory pages. For example, the access define module 116 may be configured to set read, write, and/or execute permissions for different memory regions. The permissions may be enforced using page table entries (PTEs), and violations may cause page faults. Such rules and the PTEs may be enforced using the MMU 104. In some embodiments, enforcement of such access rules may be described in further detail with respect to FIG. 3 of the present disclosure.

In some embodiments, the memory manager 103 may include a validation module 118 configured to perform one or more validation processes to protect the allocated memory pages. In some embodiments, the one or more validation processes may be performed at different stages to improve the efficiency of the validation process. For example, the validation processes may be performed as the memory pages are being allocated and/or after the memory pages are allocated. In some embodiments, the one or more validation processes may be described in further detail with respect to FIG. 2 of the present disclosure.

Modifications, additions, or omissions may be made to FIG. 1 without departing from the scope of the present disclosure. For example, the monolithic system 100 may include more or fewer elements than those illustrated and described in the present disclosure.

FIG. 2 illustrates another example monolithic system 200, in accordance with one or more embodiments of the present disclosure. In particular, FIG. 2 illustrates components of the monolithic system 200 with respect to allocation of memory pages. In some embodiments, the monolithic system 200 may correspond to the monolithic system 100 of FIG. 1. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

In some embodiments, the monolithic system 200 may include a memory manager 203 configured to allocate memory resources and/or memory pages of the monolithic system 200 to different threads. While not illustrated, the memory manager 203 may be a subsystem of a kernel, such as the kernel 102 of FIG. 1. In some embodiments, the memory manager 203 may be configured to allocate memory pages to threads that have not previously been allocated memory. For example, in response to obtaining a request to access a system memory 220 from a thread and determining that memory pages have not been allocated to the thread, the memory manager 203 may allocated one or more memory pages to the thread.

For example, a first thread 206 may request access to the system memory 220 of the monolithic system 200 via a first context 208. MMU, such as the MMU 104 of FIG. 1 may determine that the first thread 206 does not have allocated memory, and the memory manager 203 may allocate certain memory resources to the first thread 206. The system memory 220 may refer to the memory management framework including both the physical memory (e.g., the RAM installed on the monolithic system 200) and the virtual memory (e.g., an abstraction provided by the operating system). Physical memory is the hardware component where data and programs are actually stored and accessed by the processor. Virtual memory is a logical layer that allows each process and/or thread to operate as if the process and/or the thread is in private memory space. Virtual memory may be organized using virtual addresses which may be mapped by a MMU (e.g., the MMU 104 of FIG. 1) to physical memory pages. The relationships between the virtual memory and the physical memory may be defined using page tables.

In some embodiments, the system memory 220 may include one or more memory pools. For example, the system memory 220 may include a first memory pool 222a, a second memory pool 222b, a third memory pool 222c, a fourth memory pool 222d, and a fifth memory pool 222e (collectively referred to as memory pools 222). The memory pools 222 may represent different sets of memory pages that are allocated to and/or set apart for different purposes or groups of threads. In some embodiments, the memory pools may be created at kernel initialization. In some embodiments, the memory pools 222 may each include a continuous set of physical memory pages. A continuous set of physical memory pages may refer to a block of physical adjacent memory pages in RAM that are grouped together without gaps. For example, the individual memory pools of the memory pools 222 may include a set of memory pages with continuous physical page addresses. Additionally or alternatively, the memory pools 222 may be represented using virtual addresses corresponding to the physical addresses. Virtual addresses may be allocated such that continuous range of physical memories are allocated to the same memory pool 222. For example, the virtual addresses may not directly show that the pages are continuous. However, the physical addresses corresponding to the virtual addresses may correspond to continuous range of physical memory pages.

In some embodiments, each memory pool may be allocated to and/or associated with a specific purpose of processes or functionalities. For example, the memory pools may be associated with different levels of safety. For example, the memory pools may be allocated to safety-related (SR) levels. In some embodiments, different levels of safety may be defined. For example, different safety levels may include a first SR level, a second SR level, a third SR level, and a fourth SR level. Additionally, a non-SR (NSR) level may be defined. The NSR level may correspond to general functions and/or operations that do not directly affect safety of the systems.

As an example, in instances in which the processes and/or threads are assigned different safety levels based at least on a certain standard such as the ASIL standards defined by ISO 26262, the memory pools 222 may be associated with the different safety levels. For example, the memory pools 222 may correspond to different ASIL levels defined by the ASIL standards. In general, the ASIL levels may include ASIL A, ASIL B, ASIL C, ASIL D, and quality management (QM). In such an example, the ASIL A level may correspond to the first SR level, the ASIL B level may correspond to the second SR level, the ASIL C level may correspond to the third SR level, the ASIL D level may correspond to the fourth SR level, and the QM level may correspond to the NSR level.

ASIL A, the lowest requirement, is applicable to systems with minimal potential impact on safety. For example, systems such as interior light systems or seat belt warning indicators do not significantly impact safety of vehicle operations.

ASIL B represents a moderate safety requirement for systems or functionalities that may have a moderate impact of safety of vehicle operations in the event of a failure. For example, ASIL B may be applied to traction control systems that help prevent wheel spin during acceleration, enhancing vehicle stability. Failure of such system may lead to moderate impact on safety of the vehicle. As another example, ASIL B may apply to airbag deployment systems.

ASIL C represents a high safety requirement for systems with a significant impact on safety in the event of a failure. For example, ASIL C may be applicable to electronic stability control which helps maintain vehicle control during extreme steering maneuvers, preventing skidding and rollovers. As another example, ASIL C may apply to adaptive cruise control that automatically adjusts vehicle speed to maintain a safe distance from the vehicle ahead. Failure of adaptive cruise control may directly lead to rear-end collisions.

Finally, ASIL D represents the highest safety requirement for systems whose failures may lead to critical consequences. For example, ASIL D may apply to autonomous driving systems and/or braking systems. Full self-driving systems are assigned the highest safety requirements as failure of such systems may directly lead to catastrophic outcomes (e.g., collisions). Failure of braking systems may also lead to critical events such as accidents. General processes that do not fall into one of the ASIL levels may be defined as QM processes.

In these and other embodiments, the memory pools 222 may be associated with and/or allocated to the different ASIL levels. For example, the first memory pool 222a may be allocated to QM level, the second memory pool 222b may be allocated to ASIL A level, the third memory pool 222c may be allocated to ASIL B level, the fourth memory pool 222d may be allocated to ASIL C level, and the fifth memory pool 222e may be allocated to ASIL D level. In these and other embodiments, processes associated with a specific ASIL level may be permitted to use the memory pages allocated to corresponding ASIL level. While described with respect to the safety levels (e.g., the ASIL levels), the memory manager 203 may allocate the memory pages based on other suitable standards. For example, different standards may be applicable in different implementations such as robotics, aerospace, medicine, among others. In the present disclosure, a reference to a QM level or process may include a reference to a NSR level or process.

In some embodiments, the memory manager 203 may include a memory allocator 212 configured to allocate memory pages to the threads. In some embodiments, the memory allocator 212 may allocate memory pages based at least on the relationships between the threads and the memory pools 222. For example, the memory allocator 212 may be configured to select a particular memory pool to allocate the memory pages from based on the purpose and/or categorization of the threads. For example, different threads, such as the first thread 206, may be categorized into one of the ASIL levels based on the impact the threads have on the safety of the monolithic system 200. In these and other embodiments, the memory allocator 212 may allocate memory pages from the memory pools 222 that correspond to the ASIL levels of the threads.

For example, in instances the first thread 206 and the first context 208 are associated with ASIL C level, certain memory pages from the fourth memory pool 222d associated with the same ASIL C level may be allocated to the first thread 206. In these and other embodiments, any of the available memory pages from the fourth memory pool 222d may be allocated to the first thread 206. As another example, in instances the first thread 206 and the first context 208 are associated with ASIL A level, certain memory pages form the second memory pool 222b may be allocated to the first thread 206. In these and other embodiments, the memory pages allocated to the first thread 206 may be added to allocated memory pages 214. The allocated memory pages 214 may include and/or list the memory pages that are currently allocated to different threads. In some embodiments, the allocated memory pages 214 may be represented using page table entries. In other embodiments, the allocated memory pages 214 may be represented using any other suitable formats or methods.

In some embodiments, the allocation of memory may define the threads that may read and/or write to different memory pools 222. For example, a memory management unit (e.g., the MMU 104 of FIG. 1) may be configured to implement and/or enforce the allocated memory pages 214 such that the threads only read from and/or write to the memory pages that are allocated to the particular purpose associated with the threads. For example, the memory manager 203 may include an access define module 216 configured to define the rules laying out the memory pages that different threads may access (e.g., read and/or write).

In some embodiments, the memory manager 203 may include a validation module 218 configured to perform one or more validation processes to protect the allocated memory pages. In some embodiments, the one or more validation processes may be performed at different stages to improve the efficiency of the validation process. In some embodiments, the validation module 218 may correspond to the validation module 118 of FIG. 1.

In some embodiments, the one or more validation processes may include tracking the memory pages as the memory pages are allocated, such that specific memory pages are only allocated once. In these and other embodiments, allocating memory pages from the memory pools 222 including continuous ranges of memory pages may help track the allocation more efficiently. For example, the first memory pages and the last memory pages of the memory pools 222 may be tracked such that continuous range of memory pages is allocated together. In some instances, as additional memory pages are added to the ranges of memory pages, the last page of a range may be updated.

In some embodiments, additional validation processes may be performed after the memory pages are allocated. For example, the validation module 218 may verify that the allocated memory pages 214 are only allocated once. For example, the allocated memory pages 214 may be examined to verify that no overlap between different ranges of memory pages exists. For example, in some embodiments, a second validation process may include exhaustive crawling of memory pages. The exhaustive crawling may include scanning and verifying memory allocation structures. The memory allocation structures may include structures representing memory layout, such as a page table, bitmap, or linked list structure. The memory pages may be scanned to identify allocated memory pages. The allocated memory pages 214 may be marked or flagged as allocated within the memory allocation structures. In these and other embodiments, as new memory page allocations are made, the memory allocation structures may be checked to determine whether the particular memory pages are available for allocation.

In some embodiments, a third validation process may include identifying and maintaining a known pattern of allocation. For example, in instances in which the memory pages are allocated as continuous ranges, the memory pages may be allocated such that no holes exist in the ranges. For example, the memory pages may be allocated to be continuous without holes or memory pages that do not belong to the group associated with the continuous ranges.

In these and other embodiments, the allocation of memory pages using continuous ranges of memory pages based at least on specific purposes may improve the efficiency of the validation processes. For instance, the continuous ranges may reduce the system overhead associated with keeping track of allocation status of individual memory pages.

Modifications, additions, or omissions may be made to FIG. 2 without departing from the scope of the present disclosure. For example, the monolithic system 200 may include more or fewer elements than those illustrated and described in the present disclosure.

FIG. 3 illustrates a table illustrating an example of access control rule 300, in accordance with one or more embodiments of the present disclosure. The access control rule 300 may be defined by an access define module (e.g., the access define module 216 of FIG. 2) and/or a memory manager (e.g., the memory manager 103 of FIG. 1 and/or the memory manager 203 of FIG. 2). In some embodiments, the access control rule 302 may be implemented and/or enforced by an MMU (e.g., the MMU 104 of FIG. 1) and/or an access control module (e.g., the access control module 120 of FIG. 1).

The access control rule 300 may define different memory pools of memory pages that different types of contexts or threads operating via the different types of contexts may read and/or write. In these and other embodiments, writing to the memory pages may refer to writing data such that a specific region of physical memory is altered. In these and other embodiments, prior to a write may occur, the memory pages need to be allocated, mapped, and marked writable.

In response to receiving a request to access the memory from a thread (e.g., the first thread 106 of FIG. 1) running via a context (e.g., the first context 108 of FIG. 1), the MMU may determine the memory pages and/or memory pools that the thread may access. The MMU may determine such access based at least on the access control rule 303.

In some embodiments, the access control rule 300 may be illustrated with respect to one or more contexts. For example, the access control rule 300 may include a first context 302a, a second context 302b, a third context 302c, a fourth context 302d, and a fifth context 302e (collectively referred to as the contexts 302. In these and other embodiments, the contexts 302 may define the current states of respective threads. In some embodiments, the contexts 302 may define the security levels of the respective threads. For example, the contexts 302 may define different memory access levels of the respective threads.

In some embodiments, the contexts 302 may be associated with different access levels. For example, the contexts 302 may be associated with different ASIL levels. For example, the first context 302a may be a QM context, the second context 302b may be a ASIL A context, the third context 302c may be a ASIL B context, the fourth context 302d may be a ASIL C context, and the fifth context 302e may be a ASIL D context. In these and other embodiments, the contexts 302 may have access to different memory pools based at least on the respective ASIL levels.

The access levels may be described with respect to one or more memory pools. For example, the access levels may be described with respect to a first memory pool 322a, a second memory pool 322b, a third memory pool 322c, a fourth memory pool 322d, and a fifth memory pool 322e (collectively referred to as the memory pools 322). The memory pools 322 may correspond to the memory pools 222 of FIG. 2. For example, individual memory pools of the memory pools 322 may each correspond to a continuous set of physical memory pages allocated to different purposes. For example, the memory pools 322 may be allocated to different safety levels. For example, the first memory pool 322a may be allocated to QM level, the second memory pool 322b may be allocated to ASIL A level, the third memory pool 322c may be allocated to ASIL B level, the fourth memory pool 322d may be allocated to ASIL C level, and the fifth memory pool 322e may be allocated to ASIL D level. In these and other embodiments, a reference to the memory pools 322 may include a reference to the memory pages included in the memory pool 322.

In these and other embodiments, the contexts 302 or the respective threads may have access to the entire memory pool although the threads may be allocated specific memory pages. For example, a particular thread (and associated contexts) may be allocated a specific set of memory pages from a particular memory pool. The particular thread may have access to read and write to the particular memory pool. The continuous memory pages allocated to the memory pools 322 may help implement such accessibility rules more efficiently as the sets of memory pages for each memory pool are grouped together.

In some embodiments, the table 300 may illustrate the memory pools 322 that each context of the contexts 302 may read and/or write. In general, the contexts 302 may be allowed to read from all memory pools 322. For example, a thread running via the contexts 302 may be allowed to read from any of the memory pools 322. The memory pools 322 that the contexts 302 may write to may vary based at least on the safety levels associated with the contexts 302. In some embodiments, the contexts 302 may write to the memory pools 322 allocated to the same or lower safety levels as the safety levels of the contexts 302. For example, the first context 302a or the QM context may only write to the first memory pool 322a. As another example, the third context 302c may write to the first memory pool 322a, and second memory pool 322b, and the third memory pool 322c but may not write to the fourth memory pool 322d or the fifth memory pool 322e. As yet another example, the fifth context 302e may be allowed to write to the first memory pool 322a, the second memory pool 322b, the third memory pool 322c, the fourth memory pool 322d, and the fifth memory pool 322e.

In these and other embodiments, the contexts 302 with lower safety levels may be barred from writing to the memory pools 322 associated with higher safety levels such that the unexpected write operations or interferences may be reduced. The reduced interferences may help maintain and/or improve the availability of the safety related processes.

Modifications, additions, or omissions may be made to FIG. 3 without departing from the scope of the present disclosure. For example, the access control rule 300 may include more or fewer elements than those illustrated and described in the present disclosure.

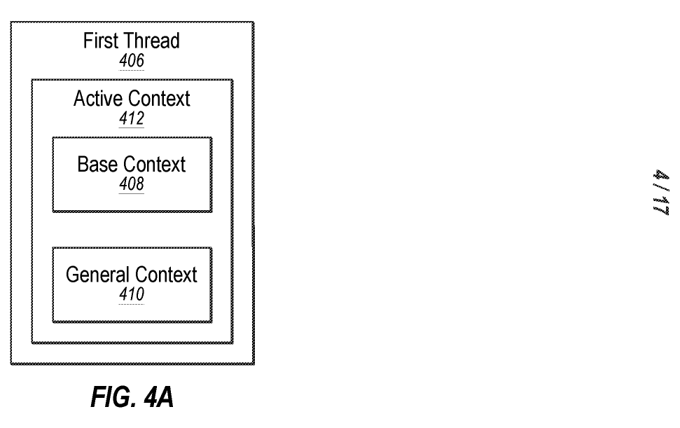

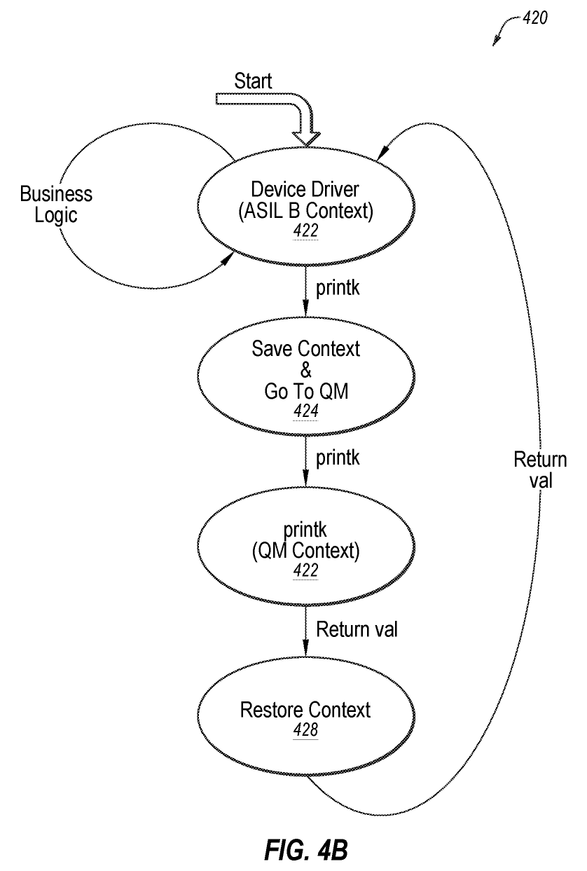

FIG. 4A illustrates a first thread 406 having multiple contexts, in accordance with one or more embodiments of the present disclosure. In particular, the first thread 406 may have a base context 408 and a general context 410. In general, the first thread 406 may be configured to transition between the base context 408 and the general context 410 to perform different operations.

In some embodiments, the base context 408 may refer to the initial state or foundational information that defines the first thread 406 when the first thread 406 is created. In some embodiments, the base context 408 may be fixed as one of the possible contexts available. For example, the base context may be one of QM context, ASIL A context, ASIL B context, ASIL C context, and ASIL D context. The base context 408 may represent the purpose (e.g., safety level) of the context or the thread. In some embodiments, the general context 410 may refer to the context in which the thread may perform general or non-safety operations. In some embodiments, the general context 410 may be referred to as a QM context.

In some embodiments, the base context 408 and the general context 410 may be part of an active context 412. The active context 412 may refer to the current state of the first thread 406 actively running or being executed by a processor. The active context 412 may control the write capability of the first thread 406. For example, the first thread 406 may be permitted to write to different memory pages based at least on the active context 412. In some embodiments, the active context 412 of the first thread 406 may be configured to switch between the base context 408 and the general context 410 based at least on the type of functions being performed by the thread 406. For example, the first thread 406 may have the base context 408 of ASIL B context. In such instance, the active context 412 may switch between the ASIL B context and the general context 410 based at least on the operations being performed by the first thread 406. In general, the active context 412 may remain as the base context 408. The active context 412 may switch to the general context 410 to perform functions that may be performed in the general context 410 (e.g., non-safety functions). In response to completing the non-safety functions, the active context 412 may return to the base context 408 (e.g., the ASIL B context).

In another instance that the first thread 406 needs to execute a function related to the base context 408(e.g., a safety-related function), the first thread 406 may switch back into or remain in the base context 408. In some embodiments, the transition between the contexts may also trigger a change of the active kernel memory map used by the MMU associated to the core running the thread. For example, as the first thread 406 is running on the general context 410, the memory map used may correspond to the QM context.

In these and other embodiments, the transition of the active context may help protect the memory pages allocated to the higher levels (e.g., higher safety or ASIL levels) as the first thread 406 is performing less important functions. For example, the first thread 406 may only write to the memory pages allocated to higher priority functions (e.g., the ASIL levels), via the base context 408. In other instances, the first thread 406 may run or operate in QM mode (e.g., operating using the QM memory pages) via the general context 410, in which the first thread 406 does not have access to the memory pages allocated to ASIL levels and/or the memory pages allocated to the same ASIL level as the base context 408. The first thread 406 may run the codes to operate in the QM mode and not alter the ASIL data stored in the memory pages allocated to the ASIL levels. Such ASIL pages may only be accessed for specific purposes and most or majority of kernel codes may be run in the QM mode.

In some embodiments, the transition between the based context 408 and the General context 410 may be implemented based at least on tagging. A tag may be a code added prior to the function. For example, ad-hoc tags may be used to facilitate the transitions. Ad-hoc tags are identifiers or markers that are added without affecting the sources (e.g., source codes).

For example, FIG. 4B illustrates a flow diagram of a transition 420 between multiple contexts, in accordance with one or more embodiments of the present disclosure. One or more operations of the transition 420 may be performed by any suitable system, apparatus, or device such as, for example, the memory management system 100 of FIG. 1, the autonomous vehicle described with respect to FIG. 9C, computing device(s) or system(s) described with respect to FIGS. 9D-12 in the present disclosure.

In general, the context transitions may be implemented using ad-hoc tags and a low-level virtual machine (LLVM). An LLVM is a modular compiler infrastructure that transforms, analyzes and optimizes source code at compile time using an intermediate representation (IR). The functionality of the LLVM may be extended using an LLVM plugin. An LLVM plugin is a dynamically loadable module that may add custom passes to the LLVM that analyze or modify code during compilation. While described with respect to the LLVM, any other suitable compilers may be used.

Ad-hoc tags (“tags”) are developer-defined markers embedded in the source code or metadata to signal specific points of interest for automated tooling, such as instrumentation, analysis, or transformation. The tags do not form a part of the language syntax but are instead used as cues—generally in the form of comments, naming conventions, or metadata annotations—for tools like compliers, or static analyzers. In some embodiments, the LLVM may load the LLVM plugin, in which the LLVM plugin is configured to locate and modify codes at specific locations based at least on the tags. For example, the LLVM plugin may search and identify the locations of the tags to modify the code at the locations corresponding to the tags. The LLVM plugin processes the function by following a series of transformations. For example, the LLVM plugin unifies the exit point of the function. The LLVM plugin further injects a preamble at the beginning of the function for recording context information. Finally, the LLVM plugin injects an epilogue just before the return statement of the function to log exit details, record return values, and/or finalize any necessary state. The use of the tags may permit the LLVM plugin to instrument code efficiently, adding tracing, logging, and/or other behaviors at specific points in the program without requiring manual modifications to the source code. In some embodiments, the LLVM plugin may modify the codes at tagged locations automatically, making the modifications consistent.

For example, at block 422, a thread may be operating via a base context. For example, the thread may be operating via an ASIL B context. In such instances, the active context of the thread may be the ASIL B context. In some embodiments, a device driver, which is configured to request memory from the kernel to be used by the threads, may be running within the context of the thread. A device driver is a kernel-level software module that handles hardware operations on behalf of kernel thread. In response to a thread invoking a system call (e.g., read() or write()), the device driver executes within the context of the thread. The driver may access the thread’s resources to perform operations.

In some embodiments, the thread may invoke a function based on a different context. For example, the thread may invoke a QM function to be performed. In these and other embodiments, the QM function may be tagged using a tag such that the LLVM plugin injects additional codes and/or modifies codes at the prior to performing the QM function. For example, the injected code may cause the thread to transition from the base context to the QM context. For example, the active context of the thread may switch from the ASIL B context (e.g., the base context) to the QM context. In the present disclosure, a reference to a QM context may include a reference to a general context.

In some embodiments, the thread may invoke or perform certain functions without switching contexts. For example, certain functions may not be tagged for such context switches. For example, business logic may not require a change of context. The business logic may refer to the rules, calculations, and processes that dictate how a system behaves based on inputs and expected outcomes, typically related to the functionality of the application or service. Business logic does not require switching between contexts as the business logic is self-contained and does not interact with system-level resources.

At block 424, the thread may enter the tagged QM function by transitioning from the base context to the QM context. For example, printk() may be called and the thread may transition from the based context to the QM context. In some embodiments, the base context may be saved such that the thread may return to the base thread in response to completing the tagged QM function.

At block 426, the thread may perform the tagged QM function via the QM context. In the QM context, printk() may be invoked to add a log message to the ring buffer. In some embodiments, the code running the thread in the QM mode or in the QM context may not alter ASIL data or the data associated with the base context, as the QM context does not have access to such data.

In some embodiments, in response to completing and exiting the tagged QM function, the active context may be restored to the base context. For example, at block 428, upon exit from the tagged function, the active context may be restored to the base context or the context of the caller of the tagged QM function.

Modifications, additions, or omissions may be made to FIG. 2 without departing from the scope of the present disclosure. For example, the resource allocation system 200 may include more or fewer elements than those illustrated and described in the present disclosure.

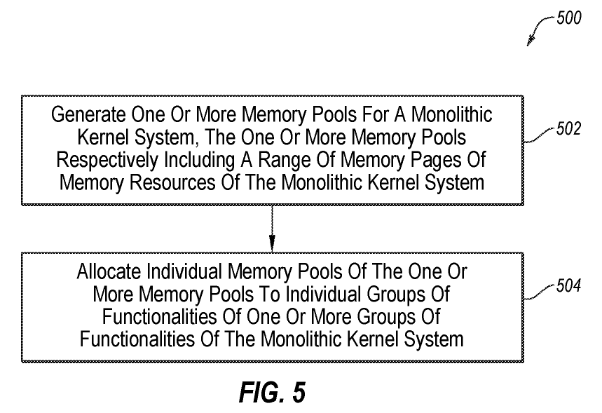

FIG. 5 is a flow diagram illustrating a method 500 of allocating memory resources of a monolithic system, in accordance with one or more embodiments of the present disclosure. One or more operations of the method 500 may be performed by any suitable system, apparatus, or device such as, for example, the memory management system 100 of FIG. 1, the memory management system 200 of FIG. 2, the autonomous vehicle described with respect to FIG. 9C, computing device(s) or system(s) described with respect to FIGS. 9D-12 in the present disclosure.

At block 502, one or more memory pools for the monolithic system (monolithic kernel system) may be generated. In some embodiments, the one or more memory pools may respectively include a range of memory pages of memory resources of the monolithic system. In some embodiments, the memory pools may correspond to the memory pools 222 of FIG. 2. In some embodiments, the range of memory pages may be continuous. For example, each memory pool may include a continuous set of memory pages. In these and other embodiments, a continuous range of memory pages may refer to a sequence of memory pages that are laid out contiguously in the physical address space with no gaps or holes between the memory pages.

In some embodiments, the range of memory pages may be defined based at least on virtual address of the memory pages corresponding to the physical addresses of memory pages. In these and other embodiments, the virtual addresses may be assigned to the one or more memory pools such that the physical addresses of memory pages are continuous. For example, the virtual addresses may not be continuous, but the physical addresses of memory pages may be continuous.

At block 504, individual memory pools of the one or more memory pools may be allocated to individual groups of functionalities of one or more groups of functionalities of the monolithic system. In some embodiments, the one or more groups of functionalities may be defined based on purposes and/or characteristics of the functionalities. For example, a set of functionalities within the same group of functionalities may share the same purpose or characteristic.

In some embodiments, the individual groups of the functionality may be grouped based at least on a categorization standard. In some embodiments, the categorization standard may include a safety standard including one or more safety levels. In these and other embodiments, the individual groups of functionalities may correspond to the one or more safety levels. For example, functionalities that are associated with or assigned to the same safety level may be grouped together.

Modifications, additions, or omissions may be made to the method 500 without departing from the scope of the present disclosure. For example, the operations of method 500 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

For example, the method 500 may further include obtaining a request to perform one or more operations with respect to the memory resources of a monolithic system from a thread. For example, the thread may request to perform an operation or a functionality that may involve one or more actions (e.g., read, write, etc.) with respect to the memory resources of the monolithic system.

In some embodiments, in response to the request, memory pages allocated to the thread may be identified. For example, a memory management unit, such as the memory management unit 104 of FIG. 1 may be configured to identify memory pages allocated to the thread. In response to determining that no memory pages have been allocated to the thread, the method 500 may include determining an assigned category of the thread. In some embodiments, the assigned category of the thread may correspond to one of the one or more groups of functionalities.

In some embodiments, an individual memory pool from the one or more memory pools that is associated with the assigned category of the thread may be identified. For example, an individual memory pool associated with the same safety level as the thread may be identified. In these and other embodiments, one or more memory pages form the identified individual memory pool may be allocated to the thread.

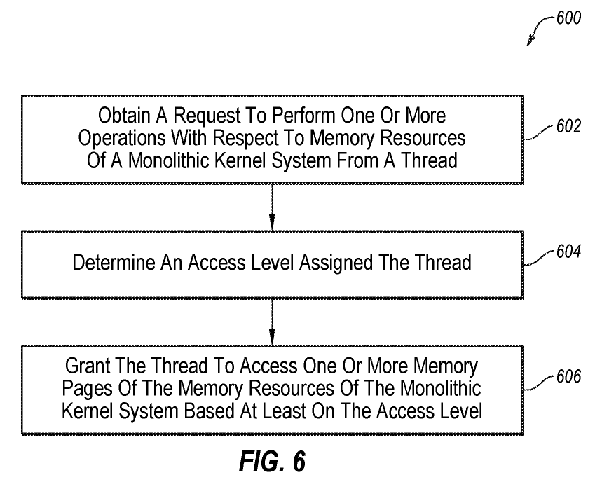

FIG. 6 is a flow diagram illustrating a method 600 of designating memory resources and/or enforcing allocated memory resources of a monolithic system, in accordance with one or more embodiments of the present disclosure. One or more operations of the method 600 may be performed by any suitable system, apparatus, or device such as, for example, the memory management system 100 of FIG. 1, the memory management system 200 of FIG. 2, the autonomous vehicle described with respect to FIG. 9C, computing device(s) or system(s) described with respect to FIGS. 9D-12 in the present disclosure.

At block 602, a request to perform one or more operations with respect to the memory resources of the monolithic system may be obtained from a thread. The one or more operations may include different operations that may affect the memory resources. For example, the one or more operations may include writing certain data to the memory resources.

At block 604, an access level assigned to the thread may be determined. In some embodiments, the access level may define one or more memory pages for the thread to read from, write to, and/or erase. In some embodiments, the access level may be one of a set of access levels, in which individual access levels of the set of access levels are assigned different tiers of access. In some embodiments, the thread may be permitted to write to memory pages associated with the access level of the thread and memory pages associated with access levels with lower tiers than the access level of the thread. In some embodiments, the thread may be permitted to read from all memory pages.

In some embodiments, the access level may be determined based at least on a type of a context the thread is operating within. A context refers to the complete state required for the thread to run. Each thread may operate within a context at a time. A thread may include multiple contexts in which the thread may operate within. In these and other embodiments, each context may be associated with a purpose and/or an access level. The access level of the context may be the same as the access level of the associated thread. In some embodiments, the type of the context may represent safety level associated with the context.

Modifications, additions, or omissions may be made to the method 600 without departing from the scope of the present disclosure. For example, the operations of method 600 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

For example, the method 600 may include assigning a category of a set of categories to individual threads of one or more threads of the monolithic kernel system based at least on one or more respective safety levels associated with the one or more threads. The threads may be assigned access levels based at least on the respective categories assigned to the individual threads.

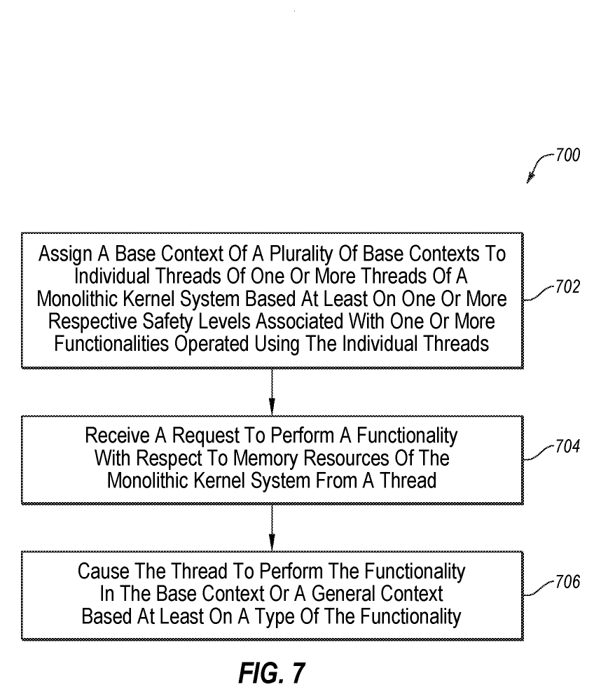

FIG. 7 is a flow diagram illustrating a method 700 of transition of contexts, in accordance with one or more embodiments of the present disclosure. One or more operations of the method 700 may be performed by any suitable system, apparatus, or device such as, for example, the memory management system 100 of FIG. 1, the memory management system 200 of FIG. 2, the autonomous vehicle described with respect to FIG. 9C, computing device(s) or system(s) described with respect to FIGS. 9D-12 in the present disclosure.

At block 702, a base context of a set of base contexts may be assigned to individual threads of one or more threads of the monolithic system based at least on one or more respective safety levels associated with one or more functionalities operated using the individual threads. In some embodiments, the base context may refer to the initial state or foundational information that defines the individual threads.

At block 704, a request to perform a functionality with respect to memory resources of the monolithic system may be received from a thread.

At block 706, the thread may be caused to perform the functionality in the based context or a general context based at least on a type of the functionality. In some embodiments, the thread may be caused to perform functionality in the base context in response to the functionality requiring a safety level associated with the base context. In some embodiments, the thread may be caused to transition to the general context for the functionality being associated with safety levels lower than a safety level associated with the base context. In these and other embodiments, the thread may be caused to transition back to the base context in response to terminating execution of the functionality.

For example, an active context of the thread may switch between the base context and the general context based at least on the type of the functionality. In these and other embodiments, the active context of the thread defines the write capability of the thread with respect to the memory resources of the monolithic kernel system.

In some embodiments, the active context may be configured to switch between the base context and the general context based at least on modifications made to the source code. For example, lines of codes may be added to the source code to cause the active context to switch between the base context and the general context. In some embodiments, the parts of the source code to be modified may be indicated using one or more tags. For example, the tags may be inserted such that the active context may transition to different contexts prior to and after performing different functionalities or processes. In some embodiments, the source code may be modified and/or the new lines of codes may be added automatically using a compiler plugin such as the LLVM plugin. The operations of the LLVM plugin may be described in further detail with respect to FIG. 4B of the present disclosure.

Modifications, additions, or omissions may be made to the method 700 without departing from the scope of the present disclosure. For example, the operations of method 700 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

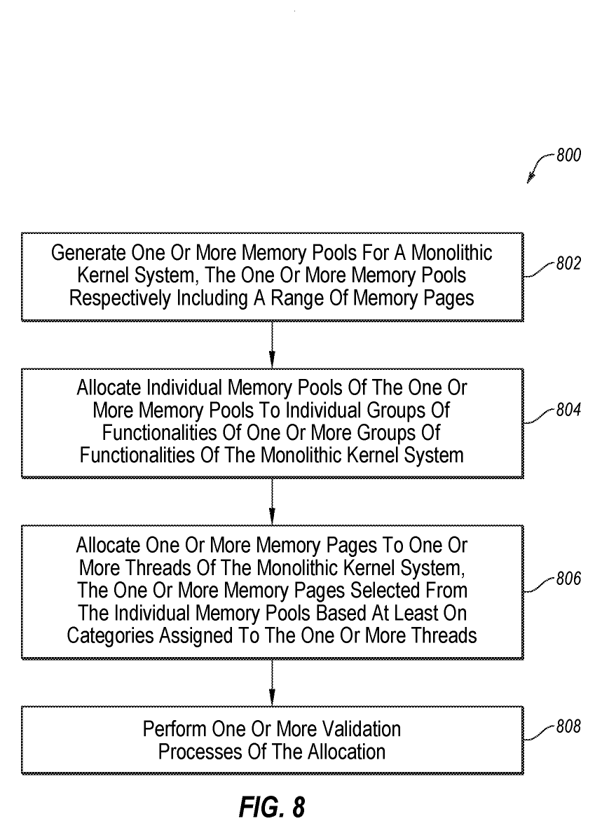

FIG. 8 is a flow diagram illustrating a method 800 of validating memory allocations, in accordance with one or more embodiments of the present disclosure. One or more operations of the method 800 may be performed by any suitable system, apparatus, or device such as, for example, the validation module 118 of FIG. 1, the validation module 218 of FIG. 2, the autonomous vehicle described with respect to FIG. 9C, computing device(s) or system(s) described with respect to FIGS. 9D-12 in the present disclosure.

At block 802, one or more memory pools may be generated for a monolithic system. In some embodiments, the one or more memory pools may respectively include a range of memory pages. In some embodiments, the range of memory pages may be continuous.

At block 804, individual memory pools of the one or more memory pools may be allocated to individual groups of functionalities of one or more groups of functionalities of the monolithic system. For example, each memory pool may be associated with a group of functionalities or a purpose.

At block 806, one or more memory pages may be allocated to one or more threads of the monolithic kernel system. In some embodiments, the one or more memory pages may be selected from the individual memory pools based at least on categories assigned to the one or more threads.

At block 808, one or more validation processes of the allocation may be performed. In some embodiments, the validation process may include tracking allocation status of individual memory pages of the memory pools. For example, as the memory pages are allocated to the one or more threads, the allocation status of the memory pages may be updated. The status may help prevent allocating the same memory pages multiple times.

In some embodiments, the status of the memory pages may be updated and/or kept track using a memory allocation structure. For example, the validation process may include generating a memory allocation structure representing layout of the memory pages. In some embodiments, allocated memory pages may be identified, and the allocated memory pages may be marked in the memory allocation structure. In some embodiments, the memory allocation structure may include one or more of a page table, a bitmap, or a linked list structure.

In some embodiments, the one or more validation processes may include verifying the allocated memory pages for overlap. For example, in response to identifying a memory page that has been allocated multiple times different threads, a page fault may be initiated, and the overlap may be mitigated. For example, the memory pages may be deallocated and/or newly allocated.

### Example Autonomous or Semi-Autonomous Machine

FIG. 9A is an example of sensor locations having corresponding fields of view or sensory fields for an autonomous or semi-autonomous vehicle 900a, an autonomous mobile robot (AMR) 900b, and a humanoid robot 900c, in accordance with some embodiments of the present disclosure. Although three types of machines 900 are illustrated, this is not intended to be limiting, and the machine(s) 900 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 900a, AMR 900b, humanoid robot 900c, and/or other machine types may be referred to herein collectively as machine 900, in some instances.

With respect to vehicles 900A, autonomous and semi-autonomous vehicles are generally described in terms of automation levels, defined by the National Highway Traffic Safety Administration (NHTSA), a division of the US Department of Transportation, and the Society of Automotive Engineers (SAE) "Taxonomy and Definitions for Terms Related to Driving Automation Systems for On-Road Motor Vehicles” (Standard No. J3016-201806, published on June 15, 2018, Standard No. J3016-201609, published on September 30, 2016, and previous and future versions of this standard). The machine 900 may be capable of functionality in accordance with one or more of Level 3 – Level 5 of the autonomous driving levels. The machine 900 may be capable of functionality in accordance with one or more of Level 1 – Level 5 of the autonomous driving levels. For example, the machine 900 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 900 or other machine, such as being fully autonomous, being highly autonomous, being conditionally autonomous, being partially autonomous, providing assistive autonomy, being semi-autonomous, being primarily autonomous, or other designation.

With respect to FIG. 9A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 968D, a 180 degree field of view of a wide-view camera 970, a 360 degree sensory field of a LiDAR sensor 964, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 900a, AMR 900b, and/or humanoid robot 900c, etc. For example, with respect to the vehicle 900a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 900b and/or humanoid robot 900c, the shape, size, purpose, implementation, model, etc. may dictate the number and types of sensors used.

As illustrated in FIG. 1A, the autonomous or semi-autonomous vehicle 900A, the AMR 900B, and the humanoid robot 900C may include different sensor types, number, and locations. For a non-limiting example, the vehicle 900A may include twelve cameras 964, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 964 may use, in embodiments, a gigabit multimedia serial link (GMSL) interface – such as GMSL2 – as input/output (I/O).

In some embodiments, although not illustrated in FIG. 9A, the vehicle 900A may include an in-cabin occupant and/or driver monitoring system, that may include various different sensors. For example, the in-cabin sensors may include various cameras 968, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 968, the internal camera(s) 968 may, in embodiments, use a GMSL (such as GMSL2) interface for I/O.

As another non-limiting example, the vehicle 900A may further include nine RADAR sensors 960. For example, the vehicle 900A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 960 may use, in embodiments, an Ethernet interface as I/O.

The vehicle(s) 900A may further include, as a non-limiting example, twelve ultrasonic sensors 962. As illustrated in FIG. 9A, the ultrasonic sensors may be positioned along the front and rear bumpers of the vehicle 900A, and along the side of the vehicle 900A, and may be used to detect objects (static and dynamic) in close proximity to the vehicle 900A. In some embodiments, the ultrasonic sensor(s) 962 may use a DS13 interface as I/O.

The vehicle(s) 900A may further include, as a non-limiting example, a LiDAR sensor 964, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 964 may include a 360 degree horizontal FOV or sensory field (such as in a spinning LiDAR sensor) and a 90 degree vertical FOV or sensory field. In some embodiment, the LiDAR sensor(s) 964 may use an Ethernet interface as I/O.

The autonomous mobile robot (AMR) 900B may include, as a non-limiting example, three LiDAR sensors 964. For example, the top-most illustrated LiDAR sensor 964 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 900B may further include, as a non-limiting embodiment, eight cameras 968, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree +- 3 degree FOV), a rear fisheye camera (e.g., 202 degree +- 3 degree FOV), a left fisheye camera (e.g., 202 degree +- 3 degree FOV), and a right fisheye camera (e.g., 202 degree +- 3 degree FOV).

The AMR 900B may further include a charging port, charging port contacts, a status indicator light, one or more (e.g., four) RGB LEDs, one or more IMU sensors 966, a magnetometer, and a barometer. The AMR 900B is capable of high-precision time synchronization between sensors using hardware time stamping, and PTP over Ethernet with less than 10 microseconds for sensor acquisition time. The AMR 900B provides simultaneous camera capture across all cameras 968 within 100 microseconds from a single hardware trigger, in embodiments, and can write to disk at 4GB/second for sensor capture to bag writing (e.g., writing to ROSbags for the robot operation system (ROS)). As such, the AMR 900B is capable of running the ROS (such as NVIDIA’s Isaac ROS), can be teleoperated (as described herein), can map an environment, and can navigate within an environment using visual cameras 968, LiDARs 964, and/or other sensor types or modalities.

The humanoid robot 900C may include, as a non-limiting example, one LiDAR sensor 964. For example, the LiDAR sensor 964 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 900C may further include, as a non-limiting embodiment, four cameras 968, such as a front stereo camera (e.g., 120 degree FOV), a rear stereo camera (e.g., 120 degree FOV), a front fisheye camera (e.g., 202 degree +- 3 degree FOV), and a rear fisheye camera (e.g., 202 degree +- 3 degree FOV).

The humanoid robot 900C may further include, as a non-limiting embodiment, four ultrasonic sensors 962, such as a left arm ultrasonic sensor, a right arm ultrasonic sensor, a left leg ultrasonic sensor, and right leg ultrasonic sensor.

The humanoid robot 900C may further include any number of actuators – such as to allow control and maneuverability of joints. For example, the humanoid robot 900C may include actuators that allow for various degrees of freedom (DoF) depending on the design. In a non-limiting embodiment, the humanoid robot 900C may have 40 total degrees of freedom (DoF) (e.g., 6 DoF x 2 for the arms, 6 DoF x 2 for the hands, 6 DoF x 2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 900C may include position and orientation sensors, such as encoders, gyroscopes, and the like, to determine the position of the robot 900C in space, allowing for location determination and movement tracking. The humanoid robot 900C may include force and pressure sensors, in embodiments, to detect environment interactions, allowing the robot 900C to grasp objects with the right force and to avoid obstacles along the way. The perception sensors (e.g., cameras, LiDARs, RADARs, ultrasonic, SONAR, etc.) may be used along with tactile sensors to allow the robot 900C to perceive objects, shapes, and textures, and to understand when touch is initiated and stopped (along with force sensors that regulate the force used during touch). As a non-limiting example, the humanoid robot 900C may have a height of about 1-2 meters (e.g., 1.7 meters or 5’ 6”), a weight of 50-70 kg, be capable of moving at a speed of 8 or more km/h, and be able to carry payloads anywhere from 20-100 kg, depending on the design and requirements of the system.

The humanoid robot 900C, in embodiments, may include a conversational system – such as a conversational system powered by language models (e.g., LLMs, VLMs, MMLMs, VLAs, etc.) – in order to help understand the environment, reason, and communicate with humans, animals, devices, and/or other robots, and/or make planning, control, and navigation decisions. As such, in addition to performing various tasks, the humanoid robot 900C may use onboard sensors, microphones, and speakers to understanding speech, audio and visual cues, etc., while also being able to communicate back to the environment.

With reference to cameras 968 of the machine(s) 900, the camera types for the cameras 968 may include, but are not limited to, digital cameras that may be adapted for use with the components and/or systems of the machine 900. For a vehicle 900a implementation, the camera(s) 968 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 968B that may be used to perceive objects coming into view from the periphery (e.g., pedestrians, warehouse vehicles, other robots, crossing traffic, or bicycles). In addition, any number of long-range camera(s) 968E (e.g., a long-view stereo camera pair) may be used for depth-based object detection, especially for objects for which a neural network has not yet been trained. The long-range camera(s) 968E may also be used for object detection and classification, as well as basic object tracking.

Any number of stereo cameras 968A may also be included in a front-facing and/or other (e.g., rear-facing) configuration. In at least one embodiment, one or more of stereo camera(s) 968A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine’s 900 environment, including a distance estimate for points in the image (e.g., a disparity or depth image). An alternative stereo camera(s) 968A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 900 (e.g., side-view cameras) may be used, for example, for surround view, providing information used to create and update the occupancy grid, as well as to generate side impact collision warnings and/or to indicate to an AMR 900B or humanoid robot 900C, for example, that there are objects, features, and/or persons present to the side. For example, surround camera(s) 968D may be positioned on the machine 900. The surround camera(s) 968D may include wide-view camera(s) 968B, fisheye camera(s), 360 degree camera(s), and/or the like. For example, four fisheye cameras may be positioned on the machine’s 900 front, rear, and sides. In an alternative arrangement, the machine 900 may use three surround camera(s) 968D (e.g., left, right, and rear), and may leverage one or more other camera(s) (e.g., a forward-facing camera) as a fourth surround view camera.

Cameras 968 with a field of view that include portions of the environment to the rear of the machine 900 (e.g., rear-view cameras) may be used for gaining an understanding of objects, features, persons, and/or other information to the rear of the machine 900, such as for park assistance, surround view, rear collision warnings, planning, control, and navigation determinations, and/or creating and updating an occupancy grid, BEV image representing the environment, height map, etc. A wide variety of cameras 968 may be used including, but not limited to, cameras 968 that are also suitable as a front-facing camera(s) (e.g., long-range and/or mid-range camera(s) 968E, stereo camera(s) 968A), infrared camera(s) 968C, etc.), rear-facing camera(s), side-facing camera(s), downward facing camera(s), upward facing camera(s), and/or the like, as described herein.

Similarly, for LiDAR sensors 964, RADAR sensors 960, ultrasonic sensors 962, and/or other sensor modalities or types, the location and placement of the sensors, and their corresponding fields of view or sensory fields may be determined based on the use case, implementation, or design of the particular machine 900.

For example, the machine(s) 900 include RADAR sensor(s) 960 that may be used by the machine 900 for long-range object detection, even in darkness and/or severe weather conditions. RADAR functional safety levels may be ASIL B, in embodiments. The RADAR sensor(s) 960 may use the CAN and/or the bus 902 (e.g., to transmit data generated by the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250m range. The RADAR sensor(s) 960 may help in distinguishing between static and moving objects, and may be used by ADAS systems for emergency brake assist and forward collision warning, by robots for detecting dynamic objects in various environments – such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine’s 900 surroundings at higher speeds with minimal interference from the periphery (e.g., from traffic in adjacent lanes). The other two antennae may expand the field of view, making it possible to quickly detect objects entering or leaving the machine’s immediate path (e.g., lane).

Mid-range RADAR systems may include, as an example, a range of up to 960m (front) or 80m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 900 (e.g., vehicle, robot, etc.). As such, short-range RADAR systems may be used in an ADAS system for blind spot detection and/or lane change assist.

The machine 900 may further include ultrasonic sensor(s) 962. The ultrasonic sensor(s) 962, which may be positioned at the front, back, and/or the sides of the machine 900, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 900. A wide variety of ultrasonic sensor(s) 962 may be used, and different ultrasonic sensor(s) 962 may be used for different ranges of detection (e.g., 2.5m, 4m). The ultrasonic sensor(s) 962 may operate at functional safety levels of ASIL B, as an example.

The machine 900 may include LiDAR sensor(s) 964. The LiDAR sensor(s) 964 may be used for object and feature detection, pedestrian and other robot detection, emergency braking, collision avoidance, simultaneous localization and mapping (SLAM), free-space detection, and/or other functions. The LiDAR sensor(s) 964 may be functional safety level ASIL B, in embodiments. In some examples, the machine 900 may include multiple LiDAR sensors 964 (e.g., two, four, six, etc.) that may use Ethernet (e.g., to provide data to a Gigabit Ethernet switch).

In some examples, the LiDAR sensor(s) 964 may be capable of providing a list of objects and their distances for a 360-degree field of view. Commercially available LiDAR sensor(s) 964 may have an advertised range of approximately 900m, with an accuracy of 2cm-3cm, and with support for a 900Mbps Ethernet connection, for example. In some examples, one or more non-protruding LiDAR sensors 964 may be used. In such examples, the LiDAR sensor(s) 964 may be implemented as a small device that may be embedded into the front, rear, sides, top, and/or corners of the machine 900. The LiDAR sensor(s) 964, in such examples, may provide up to a 120-degree horizontal and 35-degree vertical field-of-view, with a 200m range even for low-reflectivity objects. Front-mounted LiDAR sensor(s) 964 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 900. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 964 may be less susceptible to motion blur, vibration, and/or shock.

FIG. 9B is an illustration of sensor and component locations of an example autonomous or semi-autonomous vehicle 900A (alternatively referred to herein as “vehicle 900,” “ego-vehicle 900,” “ego-machine 900,” or “machine 900,”), in accordance with some embodiments of the present disclosure. Although the vehicle 900A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 9C is a block diagram of an example system architecture for a machine 900, such as autonomous or semi-autonomous vehicle 900A, autonomous mobile robot (AMR) 900B, humanoid robot 900C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises – such as locally hosted servers, remotely located – such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 900 of FIGS. 9A-9E, example computing ecosystem 1000 of FIG. 10, example generative language model system 1100 of FIG. 11, and/or example computing device 1200 of FIG. 12.

Each of the components, features, and systems of the machine 900 in FIG. 9C are illustrated as being connected via bus 902 (alternatively referred to as a “machine communications network 902,” or just “communications network 902”). The bus 902 may include a Controller Area Network (CAN) data interface (alternatively referred to herein as a “CAN bus”). A CAN may be a network inside the machine 900 used to aid in control of various features and functionality of the machine 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 902 may include FlexRay, an embedded bus (e.g., SPI, I2C), local interconnect link (LIN), NVIDIA’s NVLink, ultra accelerator Link (UALink), USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the machine 900, and two or more busses 902 may communicate with the same components. In some examples, each SoC 904, each controller 936, and/or each computer or compute engine within the machine 900 may have access to the same input data (e.g., inputs from sensors of the machine 900), and may be connected to a common bus, such as a CAN bus.

The machine 900 may include components such as a chassis, a vehicle body, wheels (e.g., 2, 4, 6, 8, 18, etc.), tires, axles, batteries, side-view mirrors, and/or other components of a vehicle or machine. The machine 900 may include a propulsion system 950, such as an internal combustion engine, hybrid electric power plant, an all-electric engine, a hydrogen-fueled engine, and/or another propulsion system type. The propulsion system 950 may be connected to a drive train of the machine 900, which may include a transmission, to enable the propulsion of the machine 900. The propulsion system 950 may be controlled in response to receiving signals from the throttle/accelerator 952.

A steering system 954, which may include a steering wheel and/or other steering device (e.g., remote steering and/or local steering), may be used to steer the machine 900 (e.g., along a desired path or route) when the propulsion system 950 is operating (e.g., when the vehicle is in motion). The steering system 954 may receive signals from a steering actuator 956. In some embodiments, a steering wheel or other steering mechanism may not be included, such as for a machine 900 capable of full automation (e.g., Level 5) functionality.

The brake sensor system 946 may be used to operate the vehicle brakes in response to receiving signals from the brake actuators 948 and/or brake sensors.

The machine 900 may include one or more controller(s) 936, such as those described herein with respect to FIG. 9A. The controller(s) 936 may be used for a variety of functions, and may be coupled to any of the various other components and systems of the machine 900. For example, the controllers 936 may be used for control of the machine 900, artificial intelligence executing on the machine 900, infotainment for the machine 900, and/or the like. For example, one controller 936 may be used for some or all of the functionality, or different controllers 936 may be used for different functionalities – e.g., to ensure availability and a safety separation between various controllers for different tasks. For example, the controller(s) 936 may use plans computed by the system – e.g., paths or trajectories for vehicles 900A or AMRs 900B, or movements, components trajectories, movement locations or displacements, etc. for joints or components (e.g., of manipulators, end effectors, limbs, hands, fingers, legs, feet, etc.), of a humanoid robot 900C – to control the machine(s) 900 in the environment. In some instances, the controller(s) 936 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 900C, for example, the controller(s) 936 may act as the brain, responsible for analyzing sensor data, making decisions, and sending commands to the actuators. The controller(s) 936 may include a low-level controller that handles basic motor control, ensuring accurate and precise movements of individual joints and actuators. The controller(s) 936 may include a high-level controller to coordinate multiple actuators and sensors, planning complex motions and adapting to changing environments.

The controller(s) 936 may include an artificial intelligence controller, in embodiments, that may use AI algorithms (e.g., DNNs, MLMs, etc.) to learn, make decisions, and autonomously perform tasks for the machine 900. In some embodiments, the controller(s) 936 may use an open-loop control algorithm that is fixed and does not adjust actions to the environment. In other embodiments, closed-loop control may be used that incorporates feedback mechanisms to monitor the robot’s performance and make necessary adjustments. In examples, the controller(s) 936 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 936, which may include one or more systems on chip (SoCs) 904 (FIG. 9C and 9D), CPUs, GPU(s), accelerator(s), etc., may provide signals (e.g., representative of commands or messages) to one or more components and/or systems of the machine 900. Although the controller(s) 936 is listed separately from the SoC(s) 904, this is not intended to be limiting, and in some embodiments one or more components of the SoC(s) 904 may perform the operations of the controller(s) 936. For example, the controller(s) may send signals to operate the machine brakes via one or more brake actuators 948, to operate the steering system 954 via one or more steering actuators 956, to operate the propulsion system 950 via one or more throttle/accelerators 952, etc. The controller(s) 936 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 900. The controller(s) 936 may include a first controller 936 for autonomous control and navigation functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 936 may handle two or more of the above functionalities, two or more controllers 936 may handle a single functionality, and/or any combination thereof.

The controller(s) 936 may provide the signals for controlling one or more components and/or systems of the machine 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LiDAR sensor(s) 964, inertial measurement unit (IMU) sensor(s) 966 (e.g., accelerometer(s), gyroscope(s), magnetic compass(es), magnetometer(s), etc.), microphone(s) 996, camera(s) 968 (e.g., stereo camera(s) 968A, wide-view camera(s) 968B (e.g., fisheye cameras), infrared camera(s) 968C, surround camera(s) 968D (e.g., 360 degree cameras), long-range and/or mid-range camera(s) 968E, and/or other camera types), speed sensor(s) 944 (e.g., for measuring the speed of the machine 900), vibration sensor(s) 942, steering sensor(s) 940, brake sensor(s) (e.g., as part of the brake sensor system 946), actuators, and/or other sensor types.

One or more of the controller(s) 936 may receive inputs (e.g., represented by input data) from an instrument cluster 932 of the machine 900 and provide outputs (e.g., represented by output data, display data, etc.) via a human-machine interface (HMI) display 934 (e.g., screen, heads-up display, mirror display, facial display, robotic display, etc.), an audible annunciator, a loudspeaker, a speaker, and/or via other components of the machine 900. The outputs may include information such as machine velocity, speed, time, map data corresponding to a map(s) 922 of FIG. 9C (e.g., from a navigation map, a Standard Definition (SD) map, a High Definition (“HD”) map, etc.), location data (e.g., the machine’s 900 location, such as on a map 922), direction, location of other vehicles (e.g., an occupancy map, height map, bird’s eye view (BEV) image, grid, etc.), information about objects and status of objects as perceived by the system, system status information, etc. For example, the HMI display(s) 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 900 may include one or more systems on a chip (SoCs) 904 (described in more detail in FIG. 9D). The SoC(s) 904 may include CPU(s) 906, GPU(s) 908, processor(s) 910, cache(s) 912, accelerator(s) 914, data store(s) 916, and/or other components and features. The SoC(s) 904 may be used to process and provide data for various operations, such as navigation, planning, reasoning, inference, perception, control, and/or actuation operations of the machine 900 in a variety of platforms and systems. For example, the SoC(s) 904 may process live perception data (e.g., from camera, LiDAR, RADAR, ultrasonic, etc.) in addition to map data corresponding to one or more maps 922 (e.g., HD map, SD map, navigational map, occupancy map, etc.) in order to make or aid in performing various operations of the machine 900. Where a map and/or AI is used, map and/or AI (e.g., model parameter updates, fine-tuning, etc.) refreshes and/or updates via a network interface 924 from one or more servers (e.g., server(s) 978 of FIG. 9E) – such as one or more servers of a cloud-based data center.

Although an SoC(s) 904 is illustrated throughout FIGS. 9A-9E, additional or alternative components and/or architectures may be used – such as multi-chip modules (MCMs), application-specific integrated circuits (ASICs), system-in-packages (SiPs), field programmable gate arrays (FPGAs), heterogeneous integration (HI), single-board computers (SBCs) – without departing from the scope of the present disclosure. For example, depending on the type of machine 900, use of the machine 900, model of the machine 900, and required capabilities of the machine 900, one or more SoCs 904 and/or alternative architectures and/or components may be used to satisfy the particular implementation.

The machine 900 may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The machine 900 may include a GPU(s) 920 (e.g., discrete GPU(s), or dGPU(s)), that may be coupled to the SoC(s) 904 via a high-speed interconnect (e.g., NVIDIA’s NVLink, ultra accelerator Link (UALink), etc.). The GPU(s) 920 may provide additional artificial intelligence functionality, such as by executing redundant and/or different neural networks, and may be used to train and/or update neural networks based on input (e.g., sensor data) from sensors of the machine 900.

The machine 900 may further include the network interface 924 which may include one or more wireless antennas 926 and/or modems (e.g., one or more wireless antennas for different communication protocols, such as a cellular antenna, a Bluetooth antenna, etc.). The network interface 924 may be used to enable wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 900 information about vehicles in proximity to the machine 900 (e.g., vehicles in front of, on the side of, and/or behind the machine 900). This functionality may be part of a cooperative adaptive cruise control functionality of the machine 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The machine 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The machine 900 may further include IMU sensor(s) 966. The IMU sensor(s) 966 may be located at a center of the rear axle of the machine 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may enable the machine 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include one or more microphone 996 placed in and/or around the machine 900. The microphone(s) 996 may be used for emergency vehicle detection and identification, among other things.

The machine 900 may further include vibration sensor(s) 942. The vibration sensor(s) 942 may measure vibrations of components of the machine, such as the arms or legs of a humanoid robot 900C, or the axle(s) of a vehicle 900A or AMR 900B. For example, changes in vibrations may indicate a change in road, walking, or traversable surfaces. In another example, when two or more vibration sensors 942 are used, the differences between the vibrations may be used to determine friction or slippage of the surface (e.g., when the difference in vibration is between a power-driven axle and a freely rotating axle).

The machine 900 may include an ADAS system 938 – such as when the machine 900 is a vehicle 900A. The ADAS system 938 may include a dedicated SoC(s), in some examples. The ADAS system 938 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 900 may further include the infotainment SoC 930 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the machine 900. In some examples, the infotainment SoC 930 may be coupled to a supervisory MCU such that the GPU of the infotainment system may perform some self-driving functions in the event that the primary controller(s) 936 (e.g., the primary and/or backup computers of the machine 900) fail. In such an example, the infotainment SoC 930 may put the machine 900 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models – such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 900 – whether a vehicle 900A, AMR 900B, humanoid robot 900C, and/or other type of machine – may include a locally stored language model(s) and/or communicate to a remotely hosted language model (e.g., via one or more APIs) to provide more detailed and in-depth communication features to the users of the machine(s) 900.

In some examples, an infotainment SoC 930, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In some embodiments, an in-cabin monitoring camera sensor may be monitored using one or more neural networks running on another or dedicated SoC – such as an in-vehicle infotainment or in-vehicle monitoring SoC, configured to identify in cabin events and respond accordingly. An in-cabin system may perform lip reading to activate cellular service and place a phone call, dictate emails, change the vehicle’s destination, activate or change the vehicle’s infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 900.

The machine 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. In other words, the instrument cluster 932 may be included as part of the infotainment SoC 930, or vice versa.

FIG. 9D is a block diagram of an example architecture of a computing system (a subset of the system described with respect to FIG. 9C), in accordance with at least some embodiments of the present disclosure. Although illustrated as an SoC(s) 904, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 904 may be an end-to-end platform with a flexible architecture that spans automation levels 2-5, or the SoC(s) 904 may be specifically designed for a specific automation level (e.g., a first SoC 904 for level 2 to level 2++, a second SoC 904 for level 3, a third SoC 904 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 2-5 autonomous vehicles as well as for safe planning, navigation, and control of AMRs 900B, humanoid robots 900C, and/or other robot or machine types.

In some embodiments, such as where the SoC(s) 904 include a GPU 908 with 2000 or more cores (e.g., 2048 cores), 60 or more tensor cores (e.g., 64 tensor cores), and a GPU max frequency of over 1 GHz (e.g., 1.3 GHz), a CPU 906 including 10 or more cores (e.g., 12 cores), with 64 bits, 3MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 909 (e.g., 2 DLAs/XNNs/NNAs/NPUs 909), and a vision accelerator – such as a programmable vision accelerator (PVA) 907, a single SoC 904) may be capable of 275 tera operations per second (TOPS) of AI performance. For example, NVIDIA’s Jetson AGX Orin 64 GB SoC satisfies these criteria, and achieves this performance.

Similarly, in embodiments where the SoC(s) 904 include a GPU 908 with 1700 or more cores (e.g., 1792 cores), 50 or more tensor cores (e.g., 56 tensor cores), and a GPU max frequency of over 900 MHz (e.g., 930 MHz), a CPU 906 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 909 (e.g., 2 DLAs/XNNs/NNAs/NPUs 909), and a vision accelerator – such as a programmable vision accelerator (PVA) 907, a single SoC 904) may be capable of 200 tera operations per second (TOPS) of AI performance. For example, NVIDIA’s Jetson AGX Orin 32 GB SoC satisfies these criteria, and achieves this performance.

In some embodiments, such as where the SoC(s) 904 include a GPU 908 with 1000 or more cores (e.g., 1024 cores), 28 or more tensor cores (e.g., 32 tensor cores), and a GPU max frequency of over 900 MHz (e.g., 1173 MHz), a CPU 906 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 909 (e.g., 1 DLA/XNN/NNA/NPU 909), and a vision accelerator – such as a programmable vision accelerator (PVA) 907, a single SoC 904) may be capable of 157 tera operations per second (TOPS) of AI performance. For example, NVIDIA’s Jetson AGX Orin NX 16 GB SoC satisfies these criteria, and achieves this performance.

In various embodiments, such as where the SoC(s) 904 include a GPU 908 with 1000 or more cores (e.g., 1024 cores), 28 or more tensor cores (e.g., 32 tensor cores), and a GPU max frequency of over 900 MHz (e.g., 1020 MHz), a CPU 906 including 6 or more cores (e.g., 6 cores), with 64 bits, 1.5 MB L2 and 4 MB L3 cache memory, and a max frequency of 1.5 or more GHz (e.g., 1.7 GHz), a single SoC 904) may be capable of 67 tera operations per second (TOPS) of AI performance. For example, NVIDIA’s Jetson Orin Nano 8 GB SoC satisfies these criteria, and achieves this performance.

The SoC(s) 904 may include one or more CPUs 906. The CPU(s) 906 may include a CPU cluster or CPU complex (alternatively referred to herein as a “CCPLEX”), in embodiments. The CPU(s) 906 may include multiple cores and/or (e.g., L2, L3) caches. For example, in some embodiments, the CPU(s) 906 may include twelve cores in a coherent multi-processor configuration. In some embodiments, the CPU(s) 906 may include four dual-core clusters where each cluster has a dedicated L2 cache (e.g., a 3 MB L2 cache). The CPU(s) 906 (e.g., the CCPLEX) may be configured to support simultaneous cluster operation enabling any combination of the clusters of the CPU(s) 906 to be active at any given time.

The SoC(s) 904 may include any type and number of GPUs 908. For example, an integrated GPU(s) (alternatively referred to herein as an “iGPU(s)”) may be used in some embodiments. The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include a cache (e.g., an L1 cache with at least 96KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA’s CUDA).

The GPU(s) 908 may be power-optimized for best performance in automotive, robotics, and/or other embedded use cases. For example, the GPU(s) 908 may be fabricated on a Fin field-effect transistor (FinFET). However, this is not intended to be limiting and the GPU(s) 908 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

The SoC(s) 904 may include any number of cache(s) 912, including those described herein. For example, the cache(s) 912 may include L0 caches, L1 caches, L2 caches, L3 caches (e.g., that are available to both the CPU(s) 906 and the GPU(s) 908 (e.g., that is connected both the CPU(s) 906 and the GPU(s) 908)), etc. The cache(s) 912 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 904 may include one or more arithmetic logic units (ALUs) 965 which may be leveraged in performing processing with respect to any of the variety of tasks or operations of the machine 900 – such as computer vision, machine learning or deep learning processing, world model management, etc. In addition, the SoC(s) 904 may include a floating point unit(s) (FPU(s)) 967 – or other math coprocessor or numeric coprocessor types – for performing mathematical operations within the system. For example, the SoC(s) 104 may include one or more FPUs 967 integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory 915 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 914 (e.g., the hardware acceleration cluster) may include a deep learning accelerator(s) (DLA) 909 (alternatively referred to herein as “a deep learning accelerator cluster (XNN) 909,” “neural network accelerator (NNA) 909,” or “neural processing unit (NPU) 909”). The DLA(s) 909 may include one or more Tensor processing units (TPUs) 941 that may be configured to provide an additional, e.g., ten trillion operations per second for deep learning applications and inferencing. The TPUs 941 may be accelerators configured to, and optimized for, performing image processing functions (e.g., for CNNs, RCNNs, DNNs, etc.). The DLA(s) 909 may further be optimized for a specific set of neural network types and floating point operations, as well as inferencing. The design of the DLA(s) may provide more performance per millimeter than a general-purpose GPU, and vastly exceeds the performance of a CPU. The TPU(s) 941 may perform several functions, including a single-instance convolution function, supporting, for example, INT8, INT16, and FP16 data types for both features and weights, as well as post-processor functions. Although the TPU(s) 941 are described as being included as part of the DLA(s) 909, this is not intended to be limiting, and the TPU(s) 941 may be included in additional or alternative accelerator(s) 914 and/or other components, and/or may be included as a discrete processing component(s).

The DLA(s) 909 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 909 may perform any function of the GPU(s) 908, and by using an inference accelerator, for example, a designer may target either the DLA(s) 909 or the GPU(s) 908 for any function. For example, the designer may focus processing of DNNs and floating point operations on the DLA(s) 909 and leave other functions to the GPU(s) 908 and/or other accelerator(s) 914. The DLA(s) 909 may be used to run any type of network to enhance control and safety, including for example, a neural network that outputs a measure of confidence for each object detection.

The accelerator(s) 914 (e.g., the hardware acceleration cluster) may include a programmable vision accelerator(s) (PVA) 907, which may alternatively be referred to herein as a computer vision accelerator or generally a vision accelerator. The PVA(s) 907 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 907 may provide a balance between performance and flexibility. For example, each PVA(s) 907 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 907 may be optimized for the tasks of image processing and computer vision algorithm acceleration. For example, the PVA(s) 907 provides excellent performance with extremely low power consumption, and can be used asynchronously and concurrently with the CPU(s) 906, GPU(s) 908, and/or other accelerators in the system (e.g., vehicle, robot, etc.) as part of a heterogeneous compute pipeline.

The PVA(s) 907 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 943 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts – ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 906 (e.g., ARM Cortex-R5 processor), facilitating data exchange with the CPU(s) 906 and other system-level components. The VPU I-cache may supply instruction data to the VPU(s) when requested, may request missing instruction data from system memory, and/or may maintain temporary instruction storage for the VPU. For each VPU task, the CPU(s) 906 may configures the DMA system, optionally prefetch the VPU program into VPU I-cache, and/or kick off each VPU-DMA pair to process a task. The PVA(s) 907 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 907 to access the system memory independently of the CPU(s) 906. The DMA may support any number of features used to provide optimization to the PVA(s) 907 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 907 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 907, and may include one or more vector processing units (VPUs), one or more pixel processing engines (PPEs) – which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 907 may be configured to employ data parallelism. For example, in some embodiments, the plurality of vector processors included in a single PVA(s) 907 may execute the same computer vision algorithm, but on different regions of an image. In other examples, the vector processors included in a particular PVA(s) 907 may simultaneously execute different computer vision algorithms, on the same image, or even execute different algorithms on sequential images or portions of an image. Among other things, any number of PVAs 907 may be included in the hardware acceleration cluster and any number of vector processors may be included in each of the PVAs. In addition, the PVA(s) 907 may include additional error correcting code (ECC) memory, to enhance overall system safety.

The accelerator(s) 914 (e.g., the hardware accelerator cluster) have a wide array of uses for autonomous and semi-autonomous machine control. The PVA(s) 907 may be a programmable vision accelerator that may be used for key processing stages in perception, robotics understanding and reasoning, ADAS, semi-autonomous, and autonomous vehicles, etc. The PVA’s 907 capabilities are a good match for algorithmic domains needing predictable processing, at low power and low latency. In other words, the PVA(s) 907 performs well on semi-dense or dense regular computation, even on small data sets, which need predictable run-times with low latency and low power. Thus, in the context of platforms for autonomous vehicles and robotics, the PVAs 907 are designed to run classic computer vision algorithms, as they are efficient at object detection and operating on integer math.

For example, according to one embodiment of the technology, the PVA 907 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 907 may perform computer stereo vision function on inputs from two monocular cameras.

In some examples, the PVA(s) 907 may be used to perform dense optical flow. According to process raw RADAR data (e.g., using a 4D Fast Fourier Transform) to provide Processed RADAR. In other examples, the PVA(s) 907 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 907, this is not intended to be limiting. In some embodiments, these components may be included in alternative or additional processing components and/or accelerator(s) 914, and/or may be included as discrete components of the SoC(s) 904 and/or other computing system architecture(s).

In some examples, the SoC(s) 904 may include a real-time ray-tracing hardware accelerator (RTA) 951 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 900 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 951 and/or a ray-tracing optimized GPU 906 – such as NVIDIA’s RTX GPU.

The accelerator(s) 914 (e.g., in the hardware acceleration cluster) may include one or more optical flow accelerators (OFAs) 911. For example, the OFA(s) 911 may be used for computing optical flow and stereo disparity between frames of sensor data (e.g., images). Optical flow may be accelerated on the OFA(s) 911 for uses such as object detection and tracking, and/or for stereo depth estimation where used for computing stereo disparity between stereo image frames (e.g., two or more frames captured using two or more image sensors with at least partially overlapping fields of view).

The SoC(s) 904 may include one or more camera serial interfaces (CSIs) 923. For example, the CSI(s) 923 may include a mobile industry processor interface (MIPI) camera serial interface (CSI) for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role. For example, the CSI 923 may include a MIPI CSI-2 connector – e.g., a 16 lane MIPI CSI-2 connector, D-PHY 2.1 (up to 40Gbps), and C-PHY 2.0 (up to 164Gbps) for supporting 16 virtual channels and six or more cameras, an 8 lane MIPI CSI-2 connector, D-PHY 2.1 (up to 20Gbps for supporting 8 virtual channels and 4 or more cameras, and/or a 2x MIPI CSI-2, 22 pin camera connector, depending on the embodiment and implementation.

The accelerator(s) 914 (e.g., the hardware acceleration cluster) may include a computer vision network on-chip (CVNOC) 963 and SRAM, for providing a high-bandwidth, low latency SRAM for the accelerator(s) 914. In some examples, the on-chip memory may include at least 4MB SRAM, consisting of, for example and without limitation, eight field-configurable memory blocks, that may be accessible by the PVA 907, OFA 911, DLA 909, and/or other accelerator(s) 914. Each pair of memory blocks may include an advanced peripheral bus (APB) interface, configuration circuitry, a controller, and a multiplexer. Any type of memory 915 may be used. The PVA 907, OFA 911, DLA 909, and/or other accelerator(s) 914 may access the memory via a backbone that provides the accelerator(s) 914 with high-speed access to memory. The backbone may include a computer vision network on-chip that interconnects the accelerator(s) 914 to the memory (e.g., using the APB).

The CVNOC 963 may include an interface that determines, before transmission of any control signal/address/data, that the accelerator(s) 914 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 904 may include data store(s) 916 and/or memory 915. The data store(s) 916 may be on-chip memory 915 of the SoC(s) 904, which may store neural networks and/or other algorithms to be executed on the CPU(s) 906, the GPU(s) 908, and/or one or more of the accelerator(s) 914. In some examples, the data store(s) 916 may be large enough in capacity to store multiple instances of neural networks for redundancy and safety. The data store(s) 912 may comprise L2 and/or L3 cache(s) 912, for example. The memory(ies) 915 may include SRAM, LPDDR5, and/or other memory types. For example, the memory(ies) 915 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 916 may include reference to the memory associated with the PVA 907, OFA 911, DLA 909, and/or other accelerator(s) 914, as described herein.

The data store(s) 116 may include various storage types, such as eMMC, NVMe, etc. For example, the SoC(s) 904 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 916 and/or other storage may be accessed via, e.g., NVMe, using PCI Express (PCIe), RDMA, TCP, and/or other protocols.

The SoC(s) 904 may include one or more processor(s) 910 (e.g., embedded processors). The processor(s) 910 may include a boot and power management processor (BPMP) 953, that may be a dedicated processor and subsystem to handle boot power and management functions and related security enforcement. The BPMP 953 may be a part of the SoC(s) 904 boot sequence and may provide runtime power management services. The BPMP 953 may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, accelerator(s) 914, and/or other components. If temperatures are determined to exceed a threshold, BPMP 953 may enter a temperature fault routine and put the SoC(s) 904 into a lower power state and/or put the machine 900 into a chauffeur to safe stop mode (e.g., bring the machine 900 to a safe stop).

The processor(s) 910 may further include a set of embedded processors that may serve as an audio processing engine (APE) 955. The APE 955 may be an audio subsystem that enables full hardware support for multi-channel audio over multiple interfaces, and a broad and flexible range of audio I/O interfaces. In some examples, the APE 955 is a dedicated processor core with a digital signal processor with dedicated RAM.

The processor(s) 910 may further include an always on processor engine (AOPE) 957 that may provide necessary hardware features to support low power sensor management and wake use cases. The AOPE 957 may include a processor core, a tightly coupled RAM, supporting peripherals (e.g., timers and interrupt controllers), various I/O controller peripherals, and routing logic.

The processor(s) 910 may further include a safety processor(s) 913 (alternatively referred to as “safety island 913”), which may include a safety cluster engine that includes a dedicated processor or processor subsystem to handle safety management for automotive, robotics, and/or other applications. The safety processor(s) 913 – and/or safety cluster engine – may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 913 may include a discrete processor(s), such that fault of other system components may not impact the performance and availability of the safety processor 913.

The processor(s) 910 may further include a real-time or near real-time sensor engine (SE) 959 that may include a dedicated processor subsystem for handling real-time or near real-time camera, LiDAR, RADAR, and/or other sensor modality management.

The processor(s) 910 may further include one or more image signal processors (ISPs) 927, which may include a high-dynamic range signal processor and/or a hardware engine that is part of one or more sensor processing pipelines.

The processor(s) 910 may include a video image compositor (VIC) 961 that may be a processing block (e.g., implemented on a microprocessor) that implements video post-processing functions needed by a video playback application to produce the final image for the player window. The VIC 961 may perform lens distortion correction on wide-view camera(s) 968B, surround camera(s) 968D, in-cabin monitoring camera sensors, and/or other camera sensors with distorted fields of view.

A VIC 961 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 961 may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a broad range of peripheral interfaces for input/output (I/O) 925, such as to enable communication with peripherals, audio codecs, power management, and/or other devices. The SoC(s) 904 may be used to process data from cameras (e.g., connected over Gigabit Multimedia Serial Link and/or Ethernet), sensors (e.g., LiDAR sensor(s) 964, RADAR sensor(s) 960, etc. that may be connected over Ethernet), data from bus 902 (e.g., speed of machine 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks. In some embodiments, the SoC(s) 904 I/O 925 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 925 elements, components, or features.

The SoC(s) 904 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 904 may include an RJ45 connector with up to 10 GbE, a 1 GbE connector, and/or other networking connector types.

The SoC(s) 104 may include one or more digital signal processors (DSPs) 943. For example, the DSP(s) 943 may include a dedicated or specialized microprocessor chip optimized for digital signal processing – such as in audio signal processing, telecommunications, digital image processing, RADAR, SONAR, LiDAR, and/or other sensor processing, speech recognition, and/or other applications.

The SoC(s) 904 may include one or more video encoders 919 and/or one or more video decoders 921. For example, the video encoder(s) 919 may include a hardware-based (e.g., as part of the GPU(s) 908) video encoder (e.g., supporting H.264, H.265, etc., and being HEVC compliant, such as NVIDIA’s NVENC) that may process image inputs (e.g., as YUV, RGB, etc.) to generate a video bit stream. The video decoder(s) 921 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA’s NVDEC). In some examples, the video decoder(s) 921 may be hardware-based (e.g., as part of the GPU(s) 908).

The SoC(s) 904 may include one or more general compute acceleration clusters (GCAC(s)) 929. For example, the GCAC(s) 929 may include various processor types that may be used to accelerate compute, such as one or more vector microcode processors (VMPs) 933, one or more multi-threaded processing clusters (MPCs) 931, one or more programmable macro arrays (PMA(s)) 935, and/or one or more other processor types. For example, the GCAC(s) 929 may include a PMA 935, two VMPs 933, and 2 MPCs 931.

The SoC(s) 904 may include one or more vector microcode processors (VMPs) 933. The VMP(s) 933, in embodiments, may include a wide vector (very long instruction word (VLIW) and single instruction multiple data (SIMD)) machine with performing various operations, such as short integral type operations common in computer vision and deep learning algorithms.

The SoC(s) 904 may include one or more multi-threaded processing clusters (MPCs) 931. The MPC(s) 931 may include a processing cluster that be, in embodiments, more versatile than a GPU, and with higher efficiency than a CPU. For example, the MPC(s) 931 may include a multi-threaded processor that allows multiple threads to share resources and execute instructions concurrently.

The SoC(s) 904 may include one or more programmable macro arrays (PMA(s)) 935. The PMA(s) 935 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 904 may include one or more display processing units (DPUs) 945 for performing hardware-accelerated image processing. For example, the DPU(s) 945 may retrieve pixel data from memory 915 and send it to a display peripheral through standard interfaces. As such, the DPU(s) 945 may handle display processing and rendering for in-machine and/or on-machine displays.

The SoC(s) 904 may include one or more application processing units (APUs) 939. For example, the APU(s) 939 may include a quad or dual-core processor with 48 KB/32 KB L1 cache with parity and ECC, along with a 1 MB L2 cache with ECC. The APU(s) 939 may support NEON instructions and single and double precision floating point operations.

The SoC(s) 904 may include one or more real-time processing units (RTPUs) 969. The RTPU(s) 969 may include a dual-core processor with 32 KB/32 KB L1 cache, and 256 KB TCM with ECC. The RTPU(s) 969 may support single and double precision floating point operations.

The SoC(s) 904 may include one or more built-in self-test (BIST) components 937. For example, the BIST component(s) 937 may include memory BIST (MBIST) to test memories of the system and/or logic BIST (LBIST) to test logic of the system. The BIST components 937 may include embedded logic for directly testing logic and/or memory of the system.

The SoC(s) 904 may include one or more dynamically reconfigurable processors (DRPs) 971. For example, the DRP(s) 971 may be used for accelerating various computing operations. For example, the DRP(s) 971 may be combined, in embodiments, with a MAC unit for use as an AI accelerator. In embodiments, the DRP(s) 971 may execute applications while dynamically switching the circuit connection configuration of the arithmetic units (e.g., ALUs) on the chip at each operating clock according to the content to be processed. Since only the necessary arithmetic circuits are used, the DRP(s) 971 may consume less power than with CPU processing and can achieve higher speed. Furthermore, compared to CPUs, where frequent external memory accesses due to cache misses and other causes will degrade performance, the DRP(s) 971 can build the necessary data paths in hardware ahead of time, resulting in less performance degradation and less variation in operating speed (jitter) due to memory accesses. The DRP(s) 971 may include a dynamic loading function that switches the circuit connection information each time the algorithm changes, enabling processing with limited hardware resources, even in robotic/automotive applications that require processing of multiple algorithms.

In some embodiments, the accelerator(s) 914 may include an OpenCV accelerator for speeding up processing of OpenCV, an open-source industry standard library for computer vision processing. In some embodiments, the combination of one or more DRP(s) 971 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 904 may include various compute engines (e.g., processors 910, CPUs 906, GPU(s) 908, accelerator(s) 914, etc.), tasks may be distributed between and among the compute engines, in some instances without common cause failures due to the discrete footprint of the compute engines. Further, because the SoC(s) 904 may include a dedicated safety processor(s) 913 (or safety island 913), critical safety or redundant operations may be performed without common cause failures from the main processing components or compute engines of the SoC(s) 914. Due to these features, the SoC(s) 904 and/or the underlying systems of the machine 900 may be capable of satisfying higher levels of safety – such as automotive safety integrity level (ASIL) D from the ISO 26262 standard.

FIG. 9E is a system diagram for communication between a cloud-based server(s) (e.g., in a data center, such as those described herein) and the example autonomous or semi-autonomous vehicle or machine 900 of FIG. 9A, in accordance with some embodiments of the present disclosure. The system 976 may include a server(s) 978, a network(s) 990, and a machine(s) 900. The server(s) 978 may include a plurality of GPUs 984(A)-984(H) (collectively referred to herein as GPUs 984), switches 982(A)-982(H) (such as PCIe 4.0/5.0/etc switches, M.2 slots, thunderbolt, USB4, NVIDIA’s NVLink, NVIDIA’s NVSwitch, GPUDirect RDMA, GPUDirect Storage, ultra accelerator Link (UALink), etc.), CPUs 980(A)-980(B) (collectively referred to herein as CPUs 980), accelerators, and/or other processor types. The GPUs 984, the CPUs 980, and the PCIe switches may be interconnected with high-speed interconnects such as, for example and without limitation, NVLink interfaces 988 developed by NVIDIA and/or PCIe connections 986 (and/or ultra accelerator Link (UALink)). In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the machine(s) 900, sensor data indicating information about new or previously unexplored locations, and/or sensor data indicating changes to previously seen/stored locations (e.g., unexpected or changed road conditions, such as recently commenced road-work). The server(s) 978 may transmit, over the network(s) 990 and to the machine(s) 900, neural networks 992, updated neural networks 992, map information 994, etc., including information regarding traffic and road conditions. The updates to the map information 994 may include updates for the HD map 922, SD map, navigation map, etc., such as information regarding construction sites, potholes, detours, flooding, and/or other obstructions. In some examples, the neural networks 992, the updated neural networks 992, the map information 994, and/or the other information may have resulted from new training and/or experiences represented in data received from any number of machine(s) 900 in the environment, and/or based on training performed at a datacenter (e.g., using the server(s) 978 and/or other servers).

The server(s) 978 may be used to train machine learning models (e.g., neural networks) based on training data. The training data may be generated by the machine(s) 900, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 900 (e.g., transmitted to the machine(s) 900 over the network(s) 990, and/or the machine learning models may be used by the server(s) 978 to remotely monitor and/or control the machine(s) 900.

In some examples, the server(s) 978 may receive data from the machine(s) 900 and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the machine 900. For example, the deep-learning infrastructure may receive periodic updates from the machine 900, such as a sequence of images and/or objects that the machine 900 has located in that sequence of images (e.g., via computer vision and/or other machine learning object classification techniques). The deep-learning infrastructure may run its own neural network to identify the objects and compare them with the objects identified by the machine 900 and, if the results do not match and the infrastructure concludes that the AI in the machine 900 is malfunctioning, the server(s) 978 may transmit a signal to the machine 900 instructing a fail-safe computer of the machine 900 to assume control, notify the passengers, and complete a safety maneuver or operation – such as to slow down, hand control back to a driver, come to a stop, and/or pull over/shut down.

For inferencing, the server(s) 978 may include the GPU(s) 984 and one or more programmable inference accelerators (e.g., NVIDIA’s TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, and Deploying AI

FIG. 10 is a system diagram illustrating a three computer ecosystem 1000, including a first computing system 1002 for generating or creating artificial intelligence (AI) – such as AI training and validation data, a second computing system 1004 for training artificial intelligence, and a third computing system 1006 (which may include or correspond to the SoC(s) 904 of FIGS. 9A-9E) deploying the AI at the edge, in accordance with at least some embodiments of the present disclosure. For example, to develop and deploy embodied or physical AI, the three computer ecosystem 1000 may be used, including three accelerated computer systems to handle physical AI training, simulation, and runtime (e.g., edge deployment). These systems may generate training data for and train multimodal foundation models (and/or other model types) using scalable, physically based simulations of the machine(s) 900 and their worlds. By doing so, simulation of machine(s) 900 may be performed at scale, allowing for refinement, testing, and optimization of skills (e.g., robot skills) in a virtual world (e.g., using NVIDIA’s OMNIVERSE) that mimics the laws of physics – helping to reduce real-world data acquisition costs and ensuring the machine(s) 900 can perform safely in controlled settings.

The computing system 1004 (e.g., NVIDIA’s DGX Platform) may be used to train and fine-tune powerful foundation and generative AI models. Models, such as general purpose foundation models (e.g., NVIDIA’s Project GR00T), may be used to enable robots and other machine(s) 900 to understand natural language and emulate movements by observing human actions. The computing system 1004 may include a platform that incorporates software, infrastructure, and expertise in a modern, unified AI development and training solution. The computing system 1004 may include individual computing devices 1010 (e.g., NVIDIA’s DGX B200, H200, etc.) and/or any number of computing devices 1010 in a data center infrastructure 1012 (e.g., NVIDIA’s DGX SuperPOD).

For example, the individual computing devices 1010 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 1010 may include memory (e.g., 4 TB memory, and storage (e.g., OS storage of 2 x 1.9 TB NVMe M.2, and internal storage of 8 x 3.84 TB NVMe U.2). The computing devices 1010 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1010 may further include, e.g., dual port quad small form-factor pluggable (QSFFP) data processing units (DPUs) (e.g., 2 dual-port QSFP112 DPUs – such as NVIDIA’s BlueField-3 DPUs), providing up to 400 Gb/s InfiniBand/Ethernet. The computing device(s) 1010 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1010 may include SuperNICs (e.g., NVIDIA’s ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1010 may include a smart host channel adapter (HCA) (e.g., NVIDIA’s ConnectX-7) to provide ultra-low latency, 400 Gb/s throughput for in-network computing acceleration engines.

The data center infrastructure 1012 may include any number of the computing devices 1010, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1010) to thousands, job scheduling and orchestration to ensure hassle-free execution of every developer’s job, AI workflow management and machine learning operations (MLOps) to move more models from prototype to production, and enterprise software to speed developer success.

The computing system 1002 (e.g., NVIDIA’s OVX servers) may provide a development and simulation platform for testing and optimizing physical AI with APIs and frameworks for simulation (e.g., NVIDIA’s DriveSIM, ISAAC Sim, ISAAC Gym, ISAAC Labetc.). The computing system 1002 allows developers to use simulation frameworks to simulate and validate robot models, and/or to generate massive amounts of physically-based synthetic data to bootstrap model training. The computing system 1002 may support learning frameworks that power robot reinforcement learning and imitation learning, to accelerate robot policy training and refinement. For example, the computing system 1002 may be used to generate any number of simulations 1008 – such as within NVIDIA’s OMNIVERSE. The computing system 1002 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA’s RTX), and generative physical AI into existing software tools and simulation workflows for, e.g., industrial and robotics use cases (e.g., NVIDIA’s OMNIVERSE). As such, the computing system 1002 may host or support a native OpenUSD software platform enabling enterprises to connect 3D pipelines and develop advanced, real-time 3D applications for industrial digitalization. With powerful ray-tracing-accelerated AI and graphics capabilities, the computing system 1002 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1002 may include individual computing devices 1014 (e.g., NVIDIA’s OVX L40S Server) and/or any number of computing devices 1014 in a data center infrastructure 1016 (e.g., NVIDIA’s OVX Systems).

The computing device(s) 1014 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4 x 16: 64 GB/s bidirectional interconnect interface, 18,176 CUDA cores, 142 ray tracing (RT) cores, and 568 tensor cores). The computing devices 1014 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs – such as an NVIDIA BlueField-3 DPU), providing up to 400 Gb/s InfiniBand/Ethernet. In some embodiments, the NICs used for the computing device(s) 1014 may include SuperNICs (e.g., NVIDIA’s ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1014 may include a smart host channel adapter (HCA) (e.g., NVIDIA’s ConnectX-7) to provide ultra-low latency, 400 Gb/s throughput for in-network computing acceleration engines. The computing device(s) 1014 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4TB NVMe).

Similar to the data center infrastructure 1012, the data center infrastructure 1016 may allow for any number of computing device(s) 1014 to be combined in cluster configuration according to a reference architecture.

The computing system 1006 may be used to deploy trained AI models on a runtime computer – such as the SoC(s) 904 described herein. For example, these computing systems 1006 may be designed for compact, on-board computing needs, including an ensemble of models for control policy, vision and language models, etc., deployed on a power-efficient on-board edge computing system 1006. Details of components, features, and capabilities of the computing system 1006 may be described in more detail herein with respect to FIGS. 9A-9E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) – such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs – such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures – such as those that rely on self-attention and/or cross-attention (e.g., between contextual data and textual data) mechanisms – may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type – including but not limited to those described herein – may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models – or layers thereof – may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated – e.g., recursively – for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources – such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents – e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc. – as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model – or version, instance, or agent – maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11 is a block diagram of an example generative language model system 1100 suitable for use in implementing at least some embodiments of the present disclosure. In the example illustrated in FIG. 11, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a MMLM, a VLA model, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data – such as OpenUSD, etc.), depending on the architecture of the generative LM 1130 (e.g., LLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization (TN), for example, by converting all characters to lowercase, removing accents, and/or or handling special cases like contractions or abbreviations to ensure consistency (e.g., converting ¼ to one quarter). Similarly, the input processor 1105 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/VLM/MMLM/etc. with external knowledge, so that answers to specific questions or queries or requests are more relevant – such as in a case where specific knowledge is required. The RAG component 1192 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve – using a RAG model performing a vector search in an embedding space, for example – the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history – or at least a summary thereof – and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents – which may result in a lack of context, factual correctness, language accuracy, etc. – graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in’s REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1101 may resample an audio file to a consistent sampling rate for uniform processing, and the embedding component 1120 may use any known technique to extract and encode audio features – such as in the form of a spectrogram (e.g., a mel-spectrogram). In some implementations in which the input 1101 includes video data, the input processor 1101 may extract frames or apply resizing to extracted frames, and the embedding component 1120 may extract features such as optical flow embeddings or video embeddings and/or may encode temporal information or sequences of frames. In some implementations in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use – or capable of accessing or using – plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated – e.g., recursively – for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources – such as the plug-ins/APIs 1195.

In some embodiments, one or more transformer engines (TEs) may be implemented. The transformer engine may use micro-tensor scaling to optimize performance and accuracy – such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices – such as GPUs – to provide better performance with lower memory utilization in both training and inference. When the TE is combined with other technologies, such as high-speed interconnects between nodes (e.g., using switches - such as NVLink or ultra accelerator Link (UALink) Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s), speaker(s), etc.), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLink, ultra accelerator Link (UALink), etc.) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs) – which may include one or more direct memory access (DMA) systems, one or more vision or vector processing units (VPUs), one or more pixel processing engines (PPEs) – e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12 – e.g., each device may include similar components, features, and/or functionality of the computing device(s) 1200. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

Example 1. A method comprising:
generating one or more memory pools for a monolithic kernel system, the one or more memory pools respectively including a range of memory pages;
allocating individual memory pools of the one or more memory pools to individual groups of functionalities of one or more groups of functionalities of the monolithic kernel system;
allocating one or more memory pages to one or more threads of the monolithic kernel system, the one or more memory pages selected from the individual memory pools based at least on categories assigned to the one or more threads; and
performing one or more validation processes of the allocation.

The method of Example 1, wherein the one or more validation processes include tracking allocation status of individual memory pages of the memory pools.

The method of Example 1, wherein the performing one or more validation processes of the allocation comprise:
generating a memory allocation structure representing layout of the memory pages;
identifying allocated memory pages of the memory pages; and
marking the allocated memory pages as allocated in the memory allocation structure.

The method of Example 1, wherein the performing one or more validation processes of the allocation comprise:
generating a memory allocation structure representing layout of the memory pages;
identifying allocated memory pages of the memory pages; and
marking the allocated memory pages as allocated in the memory allocation structure.

The method of Example 1, wherein the memory allocation structure includes one or more of a page table, a bitmap, or a linked list structure.

The method of Example 1, wherein the memory allocation structure includes a plurality of units corresponding to memory pages.

The method of Example 1, wherein the range of memory pages is continuous.

The method of Example 1, wherein the one or more validation processes comprises identifying overlaps in the allocated memory pages.

The method of Example 1, wherein the one or more validation processes further comprises mitigating the identified overlaps.

Example 2. A system comprising:
one or more processors to:
generate one or more memory pools for a monolithic kernel system, the one or more memory pools respectively including a range of memory pages;
allocate individual memory pools of the one or more memory pools to individual groups of functionalities of one or more groups of functionalities of the monolithic kernel system;
allocate one or more memory pages to one or more threads of the monolithic kernel system, the one or more memory pages selected from the individual memory pools based at least on categories assigned to the one or more threads; and
perform one or more validation processes of the allocation.

The system of Example 2, wherein the one or more validation processes include tracking allocation status of individual memory pages of the memory pools.

The system of Example 2, wherein the one or more validation processes of the allocation comprise:
generating a memory allocation structure representing layout of the memory pages;
identifying allocated memory pages of the memory pages; and
marking the allocated memory pages as allocated in the memory allocation structure.

The system of Example 2, wherein the one or more validation processes of the allocation further comprise: receiving a new allocation of a memory page; and validating the new allocation based at least on allocation status of the memory page as marked in the memory allocation structure.

The system of Example 2, wherein the memory allocation structure includes one or more of a page table, a bitmap, or a linked list structure.

The system of Example 2, wherein the memory allocation structure includes a plurality of units corresponding to memory pages

The system of Example 2, wherein the range of memory pages is continuous.

The system of Example 2, wherein the one or more validation processes comprises identifying overlaps in the allocated memory pages.

The system of Example 2, wherein the one or more validation processes further comprises mitigating the identified overlaps.

The system of Example 2, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device; a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

Example 3. One or more processors comprising processing circuitry to:
generate one or more memory pools for a monolithic kernel system, the one or more memory pools respectively including a range of memory pages;
allocate individual memory pools of the one or more memory pools to individual groups of functionalities of one or more groups of functionalities of the monolithic kernel system;
allocate one or more memory pages to one or more threads of the monolithic kernel system, the one or more memory pages selected from the individual memory pools based at least on categories assigned to the one or more threads; and
perform one or more validation processes of the allocation.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating one or more memory pools for a monolithic kernel system, the one or more memory pools respectively including a range of memory pages;
allocating individual memory pools of the one or more memory pools to individual groups of functionalities of one or more groups of functionalities of the monolithic kernel system;
allocating one or more memory pages to one or more threads of the monolithic kernel system, the one or more memory pages selected from the individual memory pools based at least on categories assigned to the one or more threads; and
performing one or more validation processes of the allocation.

2. The method of claim 1, wherein the one or more validation processes include tracking allocation status of individual memory pages of the memory pools.

3. The method of claim 1, wherein the performing one or more validation processes of the allocation comprise:
generating a memory allocation structure representing layout of the memory pages;
identifying allocated memory pages of the memory pages; and
marking the allocated memory pages as allocated in the memory allocation structure.

4. The method of claim 3, further comprising:
receiving a new allocation of a memory page; and
validating the new allocation based at least on allocation status of the memory page as marked in the memory allocation structure.

5. The method of claim 3, wherein the memory allocation structure includes one or more of a page table, a bitmap, or a linked list structure.

6. The method of claim 3, wherein the memory allocation structure includes a plurality of units corresponding to memory pages.

7. The method of claim 1, wherein the range of memory pages is continuous.

8. The method of claim 1, wherein the one or more validation processes comprises identifying overlaps in the allocated memory pages.

9. The method of claim 8, wherein the one or more validation processes further comprises mitigating the identified overlaps.

10. A system comprising:
one or more processors to:
generate one or more memory pools for a monolithic kernel system, the one or more memory pools respectively including a range of memory pages;
allocate individual memory pools of the one or more memory pools to individual groups of functionalities of one or more groups of functionalities of the monolithic kernel system;
allocate one or more memory pages to one or more threads of the monolithic kernel system, the one or more memory pages selected from the individual memory pools based at least on categories assigned to the one or more threads; and
perform one or more validation processes of the allocation.

11. The system of claim 10, wherein the one or more validation processes include tracking allocation status of individual memory pages of the memory pools.

12. The system of claim 10, wherein the one or more validation processes of the allocation comprise:
generating a memory allocation structure representing layout of the memory pages;
identifying allocated memory pages of the memory pages; and
marking the allocated memory pages as allocated in the memory allocation structure.

13. The system of claim 12, wherein the one or more validation processes of the allocation further comprise:
receiving a new allocation of a memory page; and
validating the new allocation based at least on allocation status of the memory page as marked in the memory allocation structure.

14. The system of claim 12, wherein the memory allocation structure includes one or more of a page table, a bitmap, or a linked list structure.

15. The system of claim 12, wherein the memory allocation structure includes a plurality of units corresponding to memory pages.

16. The system of claim 10, wherein the range of memory pages is continuous.

17. The system of claim 10, wherein the one or more validation processes comprises identifying overlaps in the allocated memory pages.

18. The system of claim 17, wherein the one or more validation processes further comprises mitigating the identified overlaps.

19. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

20. One or more processors comprising processing circuitry to:
generate one or more memory pools for a monolithic kernel system, the one or more memory pools respectively including a range of memory pages;
allocate individual memory pools of the one or more memory pools to individual groups of functionalities of one or more groups of functionalities of the monolithic kernel system;
allocate one or more memory pages to one or more threads of the monolithic kernel system, the one or more memory pages selected from the individual memory pools based at least on categories assigned to the one or more threads; and
perform one or more validation processes of the allocation.
